(19) United States
(12) Patent Application Publication
(10) Pub. No.: US 2016/0323925 A1
(43) Pub. Date: Nov. 3, 2016

(54) METHOD, APPARATUS, AND COMPUTER PROGRAM PRODUCT FOR INTER-AP COMMUNICATION IN NEIGHBOR AWARENESS NETWORKING ENVIRONMENT

(71) Applicant: Nokia Technologies Oy, Espoo (FI)

(72) Inventors: Olli ALANEN, Vantaa (FI); Jarkko KNECKT, Espoo (FI); Mika KASSLIN, Espoo (FI); Enrico RANTALA, Iittala (FI); Janne MARIN, Espoo (FI)

(21) Appl. No.: 14/700,487

(22) Filed: Apr. 30, 2015

(51) Int. Cl. H04W 76/02; H04W 48/16

(52) U.S. Cl. CPC H04W 76/025; H04W 48/16; H04W 88/10

(57) ABSTRACT

Embodiments enable communication between access point devices operating in a neighbor awareness network cluster. A method comprises composing, by an access point device responsible for coordinating communication in a first wireless network, a service ID indicating support for communication with other access point devices operating in a second neighbor awareness network, wherein the access point device is capable of concurrently operating as an access point in the first wireless network and participating in the second neighbor awareness network; and transmitting, by the access point device, a wireless service discovery frame to the second neighbor awareness network, the service discovery frame including the composed service ID.

### FIELD

The field of the invention relates to wireless short-range communication and more particularly to communication between wireless network access point devices operating in a neighbor awareness network cluster.

### BACKGROUND

Modern society has adopted, and is becoming reliant upon, wireless communication devices for various purposes, such as, connecting users of the wireless communication devices with other users. Wireless communication devices can vary from battery powered handheld devices to household and/or commercial devices utilizing electrical network as a power source. Due to rapid development of the wireless communication devices a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, such as GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra-high frequency radio frequency identification (UHF RFID) technologies. All of these wireless communication technologies have features that make them appropriate for various applications.

Applications for short-range wireless devices are evolving to include awareness applications providing the device with an awareness about the local network environment. Awareness applications have the promise of extending business and social networking by enabling users to share local contextual data in a peer-to-peer fashion by using their mobile wireless devices. For example, users may be able to share information in real-time for local-area business networking, social networking, dating, personal safety, advertising, publishing, and searching.

### SUMMARY

Method, apparatus, and computer program product example embodiments enable communication between access point devices operating in a neighbor awareness network.

According to an example embodiment of the invention, a method comprises:

composing, by an access point device responsible for coordinating communication in a first wireless network, a service ID indicating support for communication with other access point devices operating in a second neighbor awareness network, wherein the access point device is capable of concurrently operating as an access point in the first wireless network and participating in the second neighbor awareness network; and

transmitting, by the access point device, a wireless service discovery frame to the second neighbor awareness network, the service discovery frame including the composed service ID.

According to an example embodiment of the invention, a method comprises:

discovering, by the access point device, at least one of the other access point devices operating in the second neighbor awareness network, through operation of the second neighbor awareness network, in response to the transmitting of the wireless service discovery frame.

According to an example embodiment of the invention, a method comprises:

establishing, by the access point device, a communication channel with at least one of the other access point devices operating in the second neighbor awareness network, through operation of the second neighbor awareness network, in response to the transmitting of the wireless service discovery frame.

According to an example embodiment of the invention, a method comprises:

wherein the first wireless network is a Wi-Fi network and the service discovery frame includes a publish message that includes the service ID.

According to an example embodiment of the invention, a method comprises:

wherein the publish message carried in the service discovery frame includes information about the access point device.

According to an example embodiment of the invention, a method comprises:

wherein the first wireless network is a Wi-Fi network and the service discovery frame includes a subscribe message that includes the service ID.

According to an example embodiment of the invention, a method comprises:

wherein the subscribe message carried in the service discovery frame includes information about the access point device.

According to an example embodiment of the invention, a method comprises:

receiving, by an access point device, a wireless service discovery frame from another access point device operating in a neighbor awareness network, the service discovery frame including a service ID indicating support for communication with access point devices operating in the neighbor awareness network, wherein the access point device is capable of concurrently operating in a wireless network as an access point responsible for coordinating communication in the wireless network and also participating in the neighbor awareness network; and

establishing, by the access point device, a communication channel with the other access point device in the neighbor awareness network, through operation of the neighbor awareness network, in response to the receiving the wireless service discovery frame.

According to an example embodiment of the invention, a method comprises:

wherein the wireless network is a Wi-Fi network and the service discovery frame includes either a publish message or a subscribe message that includes the service ID.

According to an example embodiment of the invention, a method comprises:

wherein the publish message or the subscribe message carried in the service discovery frame includes information about the access point device.

According to an example embodiment of the invention, an apparatus comprises:

at least one processor;

at least one memory including computer program code;

the at least one memory and the computer program code configured to, with the at least one processor, cause the access point device at least to:

compose, by the access point device responsible for coordinating communication in a first wireless network, a service ID indicating support for communication with other access point devices operating in a second neighbor awareness network, wherein the access point device is capable of concurrently operating as an access point in the first wireless network and participating in the second neighbor awareness network; and

transmit a wireless service discovery frame to the second neighbor awareness network, the service discovery frame including the composed service ID.

According to an example embodiment of the invention, an apparatus comprises:

the at least one memory and the computer program code configured to, with the at least one processor, cause the access point device at least to:

discover at least one of the other access point devices operating in the second neighbor awareness network, through operation of the second neighbor awareness network, in response to the transmitting of the wireless service discovery frame.

According to an example embodiment of the invention, an apparatus comprises:

the at least one memory and the computer program code configured to, with the at least one processor, cause the access point device at least to:

establish a communication channel with at least one of the other access point devices operating in the second neighbor awareness network, through operation of the second neighbor awareness network, in response to the transmitting of the wireless service discovery frame.

According to an example embodiment of the invention, an apparatus comprises:

wherein the first wireless network is a Wi-Fi network and the service discovery frame includes a publish message that includes the service ID.

According to an example embodiment of the invention, an apparatus comprises:

wherein the publish message carried in the service discovery frame includes information about the access point device.

According to an example embodiment of the invention, an apparatus comprises:

wherein the first wireless network is a Wi-Fi network and the service discovery frame includes a subscribe message that includes the service ID.

According to an example embodiment of the invention, an apparatus comprises:

wherein the subscribe message carried in the service discovery frame includes information about the access point device.

According to an example embodiment of the invention, an apparatus comprises:

at least one processor;

at least one memory including computer program code;

the at least one memory and the computer program code configured to, with the at least one processor, cause the access point device at least to:

receive a wireless service discovery frame from another access point device operating in a neighbor awareness network, the service discovery frame including a service ID indicating support for communication with access point devices operating in the neighbor awareness network, wherein the access point device is capable of concurrently operating in a wireless network as an access point responsible for coordinating communication in the wireless network and also participating in the neighbor awareness network; and

establish a communication channel with the other access point device in the neighbor awareness network, through operation of the neighbor awareness network, in response to the receiving the wireless service discovery frame.

According to an example embodiment of the invention, an apparatus comprises:

wherein the wireless network is a Wi-Fi network and the service discovery frame includes either a publish message or a subscribe message that includes the service ID.

According to an example embodiment of the invention, an apparatus comprises:

wherein the publish message or the subscribe message carried in the service discovery frame includes information about the access point device.

According to an example embodiment of the invention, a computer program product comprises computer executable program code recorded on a computer readable non-transitory storage medium, the computer executable program code comprising:

code for composing, by an access point device responsible for coordinating communication in a first wireless network, a service ID indicating support for communication with other access point devices operating in a second neighbor awareness network, wherein the access point device is capable of concurrently operating as an access point in the first wireless network and participating in the second neighbor awareness network; and

code for transmitting, by the access point device, a wireless service discovery frame to the second neighbor awareness network, the service discovery frame including the composed service ID.

According to an example embodiment of the invention, a computer program product comprises computer executable program code recorded on a computer readable non-transitory storage medium, the computer executable program code comprising:

code for receiving, by an access point device, a wireless service discovery frame from another access point device operating in a neighbor awareness network, the service discovery frame including a service ID indicating support for communication with access point devices operating in the neighbor awareness network, wherein the access point device is capable of concurrently operating in a wireless network as an access point responsible for coordinating communication in the wireless network and also participating in the neighbor awareness network; and

code for establishing, by the access point device, a communication channel with the other access point device in the neighbor awareness network, through operation of the neighbor awareness network, in response to the receiving the wireless service discovery frame.

### DESCRIPTION OF THE FIGURES

FIG. 1 illustrates an example network diagram of a plurality of access point devices A, B, C, and D that are operating in a neighbor awareness network cluster 100. The access point devices A, B, C, and D are each capable of concurrently operating in a wireless network, such as a Wi-Fi network, as an access point responsible for coordinating communication in their respective wireless networks and also participating in the neighbor awareness network cluster. In the example shown, the NAN service discovery frame is broadcast by the access point device A. The access points A and B are close enough to wirelessly communicate directly with each other by means of the NAN, such that the nearest APs can hear each other. The service discovery frame includes a service ID indicating support for synchronization and communication with other access point devices in the cluster, in accordance with at least one embodiment of the present invention.

FIG. 1A illustrates an example network diagram of the plurality of access point devices A, B, C, and D and two ad hoc devices E1 and E2 that are operating in the neighbor awareness network cluster 100. In the example shown, the NAN service discovery frame is broadcast as the first hop, by the access point device A. The service discovery frame includes a service ID indicating support for synchronization and communication with other access point devices in the cluster, in accordance with at least one embodiment of the present invention.

FIG. 1B illustrates the example network diagram of FIG. 1A, wherein two indirect paths may be to be available for the NAN service discovery frame to reach the nearest access point device B in the cluster, either via the ad hoc device E1 in one additional hop or via the STA A2 in two additional hops. The figure shows the second hop of the NAN service discovery frame being retransmitted by the ad hoc device E1 to the next closest access point device B, completing the indirect transmission from access point device A to access point device B in two hops, in accordance with at least one embodiment of the present invention.

FIG. 1C illustrates the example network diagram of FIG. 1B, wherein the third hop of the NAN service discovery frame being retransmitted by the STA B1 to the next closest access point device B, completing the indirect transmission from access point device A to access point device B in three hops, in accordance with at least one embodiment of the present invention.

FIG. 2A shows an example format of a NAN service discovery frame used to carry information about the subscribed service. The figure shows the subscribe message within the NAN service discovery frame, which includes the service ID indicating support for synchronization and communication with other access point devices in the cluster, in accordance with at least one embodiment of the present invention.

FIG. 2B shows an example format of a NAN service discovery frame used to carry information about the published service. The figure shows the publish message within the NAN service discovery frame, which includes the service ID indicating support for synchronization and communication with other access point devices in the cluster, in accordance with at least one embodiment of the present invention.

FIG. 2C illustrates an example Discovery Window in 2.4 GHz, within which is transmitted the NAN Service Discovery frame, in accordance with an example embodiment of the invention.

FIG. 3A shows an example format of the Basic NAN PDU structure, which includes the NAN Service Discovery frame, in accordance with an example embodiment of the invention.

FIG. 3B shows an example format of the NAN inter-AP channel usage reporting PDU structure, which includes the NAN Service Discovery frame, in accordance with an example embodiment of the invention.

FIG. 3C shows an example format of the NAN inter-AP handover signaling PDU structure, which includes the NAN Service Discovery frame, in accordance with an example embodiment of the invention.

FIG. 4 shows an example of the protocol stack of a WLAN AP implementing NAN inter-AP communication, in accordance with an example embodiment of the invention.

FIG. 5 illustrates an example network diagram of two neighbor access point devices that are operating in a neighbor awareness network cluster. The access point devices are each capable of concurrently operating in a wireless network as an access point responsible for coordinating communication in their respective wireless networks and also participating in the neighbor awareness network cluster. The figure shows one of the access point devices transmitting a wireless service discovery frame to the other access point devices in the cluster. The service discovery frame includes a service ID indicating support for synchronization and communication with other access point devices in the cluster, in accordance with at least one embodiment of the present invention.

FIG. 6A is an example flow diagram of operational steps in either the transmitting access point A, in accordance with at least one embodiment of the present invention.

FIG. 6B is an example flow diagram of operational steps in either the receiving access point B, in accordance with at least one embodiment of the present invention.

FIG. 7 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with an example embodiment of the invention.

### DISCUSSION OF EXAMPLE EMBODIMENTS OF THE INVENTION

This section is organized into the following topics:

A. WLAN Communication Technology

B. Awareness Network Technology

C. Neighbor Awareness Networking (NAN)

D. Inter-AP Communication Within Neighbor Awareness Networking

A. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. There are 14 channels designated in the 2.4 GHz range spaced 5 MHz apart. The various amendments to the IEEE 802.11 standard were consolidated for IEEE 802.11a, b, d, e, g, h, i, j, k, n, r, s, u, v, and z protocols, into the base standard IEEE 802.11-2012, Wireless Medium Access Control (MAC) and Physical Layer (PHY) Specifications, February 2012. Since then, emerging broadband applications have stimulated interest in developing very high-speed wireless networks for short range communication, for example, the planned IEEE 802.11 ac, and the planned IEEE 802.11 ad WLAN specifications that are to provide a very high throughput in various frequency bands. Applications of these IEEE 802.11 standards include products such as consumer electronics, telephones, personal computers, and access points for both for home and office.

1. IEEE 802.11 MAC Frames and Information Elements

There are three major types of medium access control (MAC) frames in the IEEE 802.11 protocol: the management frame, the control frame, and the data frame. Management frames provide management services. Data frames carry payload data. Control frames assist in the delivery of data frames. Each of these types of MAC frame consists of a MAC header, a frame body, and a frame check sequence (FCS). The header contains control information used for defining the type of 802.11 MAC frame and providing information necessary to process the MAC frame. The frame body contains the data or information included in either management type or data type frames. The frame check sequence is a value representing a cyclic redundancy check (CRC) over all the fields of the MAC header and the frame body field.

Management frames are used to provide management services that may be specified by variable-length fields called information elements included in the MAC frame body. An information element includes three fields: its function is identified by an element ID field, its size is provided by a length field, and the information to deliver to the recipient is provided in a variable-length information field.

2. IEEE 802.11 Beacon, Probe Request and Response

a. Beacon

The beacon frame is a management frame that is transmitted periodically to allow wireless devices to locate and identify a network. The beacon frame includes the fields: timestamp, beacon interval, and capability information. The timestamp contains the value of the device's synchronization timer at the time that the frame was transmitted. The capability information field is a 16-bit field that identifies the capabilities of the device. The information elements in a beacon frame are the service set identifier (SSID), the supported rates, one or more physical parameter sets, an optional contention-free parameter set, and an optional traffic indication map.

i. Infrastructure BSS Networks with an Access Point

In an Infrastructure BSS Networks with an Access Point, beacon frames are used for enabling wireless devices to establish and maintain orderly communications. The beacon frames are transmitted by the Access Points at regular intervals and include a frame header and a body with various information, including a Service Set Identifier (SSID) identifying the name of a specific WLAN and a beacon interval specifying the intended time interval between two beacon transmissions. One important purpose of the beacon frames is to inform the wireless devices about the presence of an Access Point in the area. The access point in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point in an Infrastructure BSS may bridge traffic out of the BSS onto a distribution network. STAs that are members of the BSS may exchange packets with the AP.

ii. Ad Hoc IBSS Networks

The first ad hoc wireless device to become active establishes an IBSS and starts sending beacons to inform the other wireless devices about the presence of an ad hoc network in the area. Other ad hoc wireless devices may join the network after receiving a beacon and accepting the IBSS parameters, such as the beacon interval, found in the beacon frame.

Each wireless device that joins the ad hoc network may send a beacon periodically if it doesn't hear a beacon from another device within a short random delay period after the beacon is supposed to be sent. If a wireless device doesn't hear a beacon within the random delay period, then the wireless device assumes that no other wireless devices are active in the ad hoc network and a beacon needs to be sent.

A beacon signal is periodically transmitted from the ad hoc network. The beacon frame is transmitted periodically and includes the address of the sending device.

b. Probe Request

The probe request frame is a management frame that is transmitted by a wireless device attempting to quickly locate a wireless LAN. It may be used to locate independent basic service sets (IBSSs), infrastructure basic service sets (BSSs) or mesh basic service sets (MBSSs) only or any of them. It may be used to locate a wireless LAN with a particular SSID or to locate any wireless LAN. The probe request frame may contain a service attribute request.

For active scans, the wireless device either broadcasts or unicasts a probe request on the channel it is scanning. It may set the SSID in the probe request to a wildcard SSID or to a specific SSID value. It may set the BSSID in the probe request a wildcard BSSID or to a specific BSSID value. With these options the wireless device can look for any SSID or BSSID, any representative of a specific SSID or a specific BSSID. The wireless device will add any received beacons or probe responses to a cached basic service set identifier (BSSID) scan list. For passive scans, the wireless device does not send a probe request, but instead, listens on a channel for a period of time and adds any received beacons or probe responses to its cached BSSID scan list. The wireless device may scan both infrastructure and ad hoc networks, regardless of the current setting of its network mode. The wireless device may use either the active or passive scanning methods, or a combination of both scanning methods. The wireless device performs the scan across all the frequency channels and bands that it supports. There are 14 channels designated in the 2.4 GHz range spaced 5 MHz apart.

i. Infrastructure BSS Networks with an Access Point

The wireless device may transmit a probe request and receive a probe response from the access point AP in the BSS. The probe request is transmitted by a wireless device to obtain information from another station or access point. For example, a wireless device may transmit a probe request to determine whether a certain access point is available. In the infrastructure BSS, only the AP responds to probe requests. The probe response sent back by the AP contains a timestamp, beacon interval, and capability information. It also includes the Service Set Identity (SSID) of the BSS, supported rates, and PHY parameters. The wireless device STA may learn that the access point AP will accept the STA's credentials.

The rules applied by the scanning wireless device (i.e. scanner) and the APs with active scanning are as follows:

1) Scanner (for each channel to be scanned):
a. Transmit a probe request frame (or multiple of thereof) with the SSID and the BSSID fields set as per the scan command;
b. Reset ProbeTimer to zero and start it upon the probe request transmission;
c. If nothing is detected (any signal with high enough energy) on the channel before the ProbeTimer reaches MinChannelTime (a.k.a Min_Probe_Response_Time), then go to scan the next channel (if any), else when the ProbeTimer reaches MaxChannelTime (i.e., Max_Probe_Response_Time), process all received probe responses and go to scan the next channel (if any).

2) APs:
a. An AP shall respond with a probe response only if:
   i. The Address 1 field in the probe request frame is the broadcast address or the specific MAC address of the AP; and
   ii. The SSID in the probe request is the wildcard SSID, the SSID in the probe request is the specific SSID of the AP, or the specific SSID of the AP is included in the SSID list element of the probe request, or the Address 3 field in the probe request is the wildcard BSSID or the BSSID of the AP.
b. Some further conditions may be set as well for the generation of a probe response.

In general, the probe request transmitter specifies the conditions that wireless devices need to meet in order to respond to with a probe response. All wireless devices that fulfill the condition try to send a probe response frame. The active scanning mechanism defines the signaling.

ii. Ad Hoc IBSS Networks

The effect of receiving a probe request is to cause the wireless device to respond with a probe response if the conditions indicated in the probe request are met. When a wireless device arrives within the communication range of any member of an ad hoc network, its probe request frame inquiry signals are answered by a member of the ad hoc network detecting the inquiry. A device in an ad hoc network that broadcasted the latest beacon in the network responds to the probe request frame inquiry signals with a probe response containing the address of the responding device. The probe response frame also includes the timestamp, beacon interval, capability information, information elements of the SSID, supported rates, one or more physical parameter sets, the optional contention-free parameter set, and the optional ad hoc network parameter set.

Once a device has performed an inquiry that results in one or more ad hoc network descriptions, the device may choose to join one of the ad hoc networks. The joining process may be a purely local process that occurs entirely internal to the wireless device. There may be no indication to the outside world that a device has joined a particular ad hoc network. Joining an ad hoc network may require that all of the wireless device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the wireless device has joined the ad hoc network and is ready to begin communicating with the devices in the ad hoc network.

c. Probe Response

The probe response sent back by a wireless device that met the conditions set by the received probe request contains a timestamp, beacon interval, and capability information. It also includes the Service Set Identity (SSID) of the BSS, supported rates, and PHY parameters.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear to send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 and before a probe response is transmitted, wireless devices normally employ a spectrum sensing capability during the SIFS interval or DIFS interval, to detect whether the channel is busy. A carrier sensing scheme may be used wherein a node wishing to transmit a probe response has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission of a probe response for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle for a predetermined time interval. After every received frame one may however wait for a DIFS before sensing the channel status and resuming backoff counter update.

B. Awareness Network Technology

Applications for short-range wireless devices are evolving to include awareness applications providing the device with an awareness about the local network environment. A non-limiting example awareness network architecture is the Nokia AwareNet framework, a network of wireless mobile devices self-organizing to support various applications, ranging from social networking to service discovery. Awareness information may be shared by a short-range wireless device sending an anonymous flooding message that may include a query, over an ad hoc network. A neighboring short-range wireless device may reply to the flooding message over the ad hoc network with a response, such as a pointer to a discovered location-based service.

Awareness information may include any information and/or context about a local network environment as well as the users and communication devices within the local network environment. Wireless devices may continuously collect and exchange information with other devices in a local network environment. Awareness applications running on short-range wireless devices may create a network for sharing awareness information, locate and organize awareness information, form communities for sharing awareness information, manage power consumption for devices engaged in sharing awareness information, develop applications to take advantage of the awareness information, and maintain the privacy and anonymity of users sharing awareness information.

Awareness applications running on short-range wireless devices, build upon a scheme in which every device is responsible for participating in beaconing and all the other basic operations that keep the ad hoc network in operation. An ad hoc network may be designed to have one network identifier (NWID) that all of the devices in the network share. The NWID may be announced in the beacons transmitted by the devices. In the overall design, those devices that operate under same NWID are driven to use a common and shared schedule to allow for awareness information gathering among all the devices within range. The determination of which schedule is used by a device may be made by the network instance timer value, and this timer value is communicated in beacons in the timing synchronization function (TSF) value parameter. The devices may be required to operate by assuming the oldest TSF value (i.e. largest TSF value) contained in the received beacons that represent the network with the NWID in which the devices are operating. Alternatively the devices may be required to select the schedule which to follow based on some other criteria than the TSF value. Beacons may, as an example, contain some other information than the TSF that is used by the devices to determine which schedule to use.

When the radio and MAC of a wireless device transmits a Beacon, the Beacon MAC-header contains device's own current TSF value. The device may automatically transmit a reply message when it receives a Beacon from another network, the reply message being referred herein as a beacon response message. The beacon response message contains the current TSF value of the replying network. Alternatively the beacon response message may contain other information that is used to determine which schedule to use.

Wireless devices form a network where all devices in proximity may communicate with each other. When two or more groups of devices forming two or more instances of the network come close to each other, the two or more instances may merge to become one network instance. Devices may make a merging or join decision to change the instance autonomously based on the TSF information collected from Beacons received during scan periods or based on the TSF information collected from received beacon response messages. A merging decision may be performed when a device receives a Beacon or beacon response message with an older (greater) TSF value from another wireless device. Alternatively a merging decision may be done based on some other information available in a Beacon or beacon response message from another wireless device. After the merging decision has been performed by a device, the device moves into the new network instance.

The awareness functionality in a short-range wireless device may be divided between four layers in the awareness architecture. The Awareness Layer and the Community Layer provide services for applications, i.e. provide the awareness API. The approximate functional split between the different layers is as follows.

Awareness Layer

According to an embodiment, Awareness Layer (AwL) has the highest level of control of the awareness architecture. Example services the AwL offers to the applications comprise Publish and Subscribe. The Awareness Layer receives publish and subscribe requests from applications and maps these into queries and query responses that, in turn, are mapped as awareness messages, the Network Layer PDU, that traverse from device to device. It also maps the awareness messages received by the device, to the application. The network layer does not appear as a data pipe for applications. A single awareness message is self-contained and short, the AwL compresses the messages in order for them to consume as little resources as possible.

The Awareness Layer may comprise an internal storage of awareness data items. Publishing an item normally means storing it in this internal storage (passive publish). Such an item is visible to other devices in the local vicinity and may be found using the Subscribe service. It is also possible to use active publishing that causes the Awareness Layer to issue a publish message that propagates from device to device. It is the responsibility of the AwL to decide whether a received message leads to the notification of an application (filtering). Items may be marked to be visible to only certain communities, so that they are visible only to searches made by members of such a community.

The Subscribe request causes the Awareness Layer to issue either a single or repetitive query message(s) that eventually propagate to other devices in the local vicinity (by using the functionality of lower awareness layers). When such a query message reaches the AwL of a device that happens to possess a matching information item, it responds with a reply message. The lower layers of awareness architecture take care of the routing of such a message back to the AwL of the querying device, which notifies the application of the other device that issued the Subscribe request.

Community Layer

The concept of communities has been integrally built into awareness architecture. Awareness communication may be visible to all the devices, or just to those that belong to a certain community. Regardless of this visibility, all wireless devices take part in the routing of messages. The role of the Community Layer (CoL) is to implement the community visibility rules. Only those messages that a certain device has visibility to (i.e. a device belongs to the same community as the message) are passed to the AwL. As an additional level of community privacy, messages are encrypted by the Community Layer. To allow such message filtering and encryption/decryption, the CoL stores the community credentials for those communities to which the user of the device belongs. The default awareness community (all local users) does not use any credentials and therefore its messages simply pass through the Community Layer.

According to an example embodiment, Awareness architecture comprises three different kinds of communities: the default awareness community, peer communities and personal communities. Communities may also be categorized with their privacy. Messages of public communities are transmitted as plain text whereas messages of private communities are transmitted encrypted. The default awareness community is the default community for all wireless devices. Awareness community messages are not encrypted and every node may send and receive awareness community messages (public community). In a peer community all members are equal and every member may receive all the community specific messages. A peer community may be public, or it may be private meaning that community messages are encrypted using a temporary key derived from the community specific shared key. The encryption function may be based on Advanced Encryption Standard, EAX mode (AES/EAX) with 128 bit keys. A personal community has a community owner that manages the community. A non-owner community member may communicate with the owner but not with other members of the community. A personal community is private, meaning that community messages from the owner to other members may be encrypted.

Network Layer

The Network Layer (NL) takes care of the local dissemination of the awareness messages. This is accomplished by way of a smart-flooding algorithm that attempts to adapt to the surrounding device density. At high densities, very few devices participate in the transmission of a given message. At low densities, all the devices may retransmit each message (normal flooding). The awareness network has a flat hierarchy; none of the devices may assume any special roles. Thus, at high densities, all the devices will transmit approximately the same amount of traffic (no clustering). The Network layer may also take care of the routing of the replies back to the device that issued the search. To this end, it collects routing information from the messages that flow through it. It also keeps track of all the neighbors and their approximate distance. Normally, reply routing uses unicast transmissions, whereas flooding messages are always broadcasted. All the messages received by the Network Layer are passed to Community Layer in order to check whether the message should be processed in the AwL.

Link Layer

Link Layer performs the adaptation between the underlying radio technology (e.g. IEEE 802.11 WLAN physical layer) and the Network Layer. It maps the specific information of the radio technology, such as radio identifiers and received signal strengths, into technology neutral information used by the Network Layer (NL). Multiple Link Layer instances may be used by the NL, e.g. for simultaneous usage of different radio technologies.

The Link Layer may be divided into two sub layers: logical link control (LLC) and media access control (MAC). LLC provides radio technology agnostic service for the Network Layer. It hides differences between radio technology specific MACs. LLC provides a single service access point for the Network layer. LLC knows how to map the generic provided service to the service provided by the technology specific MACs. The LLC internal data structures include the Neighbor Table that contains information of all the neighboring devices that have been heard in the recent past.

The Link Layer tries to transmit data via the given medium using the TransmitData functionality. Transmission may succeed or it may fail. Internally the Link Layer may try transmissions several times if a medium is temporarily busy. The Link Layer passes all the messages it receives to the Network Layer. This also includes unicast messages that are intended for other nodes.

The logical link control (LLC) is aware of radio technology specific MACs. In case of the IEEE 802.11 WLAN MAC example, the LLC does the following WLAN MAC specific actions:
Control (Reset, Configure) WLAN MAC.
Decide when to merge WLAN networks.
Construct a message package to be sent to WLAN MAC from outgoing messages.
Select which messages are to be sent and which are ignored immediately, e.g. if there are too many messages to be sent.
Extract incoming data messages contained in reception reports.
Update the Neighbor Table when reception reports and scan reports are received.

Merging of WLAN networks may be the responsibility of the logical link control (LLC). The LLC may determine when to merge two WLAN network instances or beacon groups as a single larger network instance or a beacon group. LLC may calculate an estimate of its own WLAN network size. Estimation may be based on information provided by the Network Layer, information found in the LLC Neighbor Table and network size category shared by other nodes. A network size category is calculated from an estimated network size.

The IEEE 802.11 WLAN MAC awareness mode enables a wireless device to use its power efficiently. In the awareness mode, the WLAN radio is asleep most of the time, thus reducing power consumption. Messages are transmitted and received in a batch mode, i.e. LLC passes all the messages that the MAC is to transmit during a single awake period, in a single package. The MAC passes all the messages received during a single awake period in a single reception report. The LLC collects messages to be transmitted in a single package. When the MAC is awake, the LLC passes the package to the MAC and it tries to transmit the messages. When the MAC is about to go asleep, it sends a transmission report to the LLC containing information about messages it has succeeded to transmit and about messages it has failed to transmit. In addition MAC passes a reception report to LLC. The report contains messages received during the awake period.

According to an embodiment, the merging or joining process is a purely local process that occurs entirely internally to the wireless device. There is no indication to the outside world that a device has joined a particular ad hoc network. Joining an ad hoc network may require that all of the mobile device's MAC and physical parameters be synchronized with the desired ad hoc network. To do this, the device may update its timer with the TSF value of the timer from the ad hoc network description, modified by adding the time elapsed since the description was acquired. This will synchronize the device's timer to the ad hoc network. The BSSID of the ad hoc network may be adopted, as well as the parameters in the capability information field. Once this process is complete, the wireless device has joined the ad hoc network and is ready to begin communicating with the wireless devices in the ad hoc network.

The IEEE 802.11 WLAN MAC awareness mode provides the following functionalities:
Reset MAC.
Configure MAC.
Join a WLAN network or create a new network.
Join an existing WLAN network (BSSID is known).
Set a template for beacon frames so that LLC parameters can be passed in WLAN beacon frames.
Try to transmit a set of messages.
Receive a set of incoming messages.
Receive a set of WLAN scan messages

Message Propagation

According to an embodiment, the propagation of an awareness search message is conducted in the awareness architecture layers of different devices. An application initiates a subscription in the device by using the Subscribe service offered by the Awareness Layer. The Awareness Layer realizes the subscription by sending a query message to other devices. In all the devices the message goes at least up to the Community Layer. However, only in those devices that belong to the community to which the message was intended, does the message proceed to the AwL. There is no need to have an application present in the replying device. It is sufficient to only have the awareness platform active.

C. Neighbor Awareness Networking (NAN)

In accordance with an example embodiment, the invention may be used in the logical architecture of the Neighbor Awareness Networking (NAN) program being standardized by the Wi-Fi Alliance (WFA). The program is publicly known as Wi-Fi Aware™.

A NAN Network operates in only one channel in the 2.4 GHz frequency band and, optionally, in one channel in the 5 GHz frequency band of the spectrum used by IEEE 802.11. The NAN Channel in the 2.4 GHz frequency band shall be channel 6 (2.437 GHz).

A NAN Device is any device that implements the NAN protocol. A NAN Cluster is a collection of NAN devices that are synchronized to the same Discovery Window schedule. A NAN Device that creates a NAN Cluster defines a series of discovery window starting times exactly 512 TUs apart in the mandatory 2.4 GHz frequency band NAN Channel. NAN Devices participating in the same NAN Cluster are synchronized to a common clock.

NAN Synchronization Beacon

A NAN Synchronization Beacon is a modified IEEE 802.11 Beacon management frame transmitted inside NAN Discovery Windows used for NAN timing synchronization. A TSF keeps the timers of all NAN Devices in the same NAN Cluster synchronized. The TSF in a NAN Cluster shall be implemented via a distributed algorithm that shall be performed by all NAN Devices. Each NAN Device participating in a NAN Cluster shall transmit NAN Beacon frames according to the algorithm described in this clause.

A Discovery Window starts at each discovery window starting time. The discovery window duration shall be 16 TUs. During a discovery window, one or more NAN Devices transmit NAN Synchronization Beacon frames such that all NAN Devices within the NAN Cluster synchronize their clocks. A NAN Device transmits at most one NAN Synchronization Beacon frame within one discovery window.

NAN Service Discovery Frame

During a discovery window, one or more NAN Devices transmit a NAN Service Discovery frame, which is a Vendor Specific Public Action frame. The NAN Service Discovery Frame is an IEEE 802.11 management frame, transmitted by a NAN device in a NAN cluster. NAN Service Discovery frames enable NAN Devices to look for services from other NAN Devices and make services discoverable for other NAN Devices. There are two NAN Service Discovery protocol messages defined in the NAN Service Discovery Protocol:

1. Publish message

2. Subscribe message

The NAN Service Discovery protocol messages are carried in Service Descriptor attributes that are carried in the NAN Service Discovery frames. A NAN Device may use a NAN Service Discovery frame to actively look for availability of a specific service. When a NAN Device uses a Subscribe message, it asks for other NAN Devices operating in the same NAN Cluster to transmit a Publish message when response criteria are met. A NAN Device may use a Publish message to make its service discoverable for other NAN Devices operating in the same NAN Cluster in an unsolicited manner. The Service Control field indicates if the Service Descriptor attribute corresponds to Publish, Subscribe, or Follow-up function and if other optional fields are present in the Service Descriptor attribute such as Matching Filter, Service Response Filter, and Service specific information.

The NAN Service Discovery Frame is an IEEE 802.11 management frame that includes fields for Frame Control, Duration, Receive address (NAN Network ID), Transmit address, Cluster ID, Sequence Control, HT Control (presence indicated with the Frame Control), the NAN Service Discovery Frame Body, and a cyclic redundancy code (CRC). The NAN Service Discovery Frame Body includes NAN attributes specifying, for example, service ID attributes and service descriptor attributes. A service descriptor attribute may be used in NAN Service Discovery Frame.

NAN Discovery Beacon Frames

Between discovery windows, one or more NAN Devices transmit NAN Discovery Beacon frames to enable NAN Devices to discover a NAN Cluster. Each NAN Device in a Master role shall transmit NAN Discovery Beacon frames outside NAN Discovery Windows in order to facilitate the discovery of the NAN Cluster. A NAN Discovery Beacon is a modified IEEE 802.11 Beacon management frame transmitted outside NAN Discovery Windows.

The NAN protocol stack in a NAN device is expected to comprise of two components: 1) NAN Discovery Engine, 2) MAC with NAN support. MAC with NAN support provides means for NAN devices to synchronize in time and frequency to provide common availability periods for service discovery frames from/to the NAN Discovery Engine.

NAN Discovery Engine

The NAN Discovery Engine provides Publish and Subscribe services to the applications for service discovery purposes.

Publishing is the ability to make application-selected information about e.g. capabilities and services available for other NAN devices that seek information with Subscribing, using protocols and mechanisms certified by the Neighbor Awareness Networking program. NAN devices that use Publishing may provide published information in an unsolicited or solicited manner. Publishing is defined for a Wi-Fi NAN as a mechanism for an application on a NAN Device to make selected information about the applications capabilities and services available to other NAN devices.

Subscribing is the ability to discover information that has been made available in other NAN devices with Publishing, using protocols and mechanisms certified by the Neighbor Awareness Networking program. NAN devices that use Subscribing may passively listen for or actively seek published information. Subscribe is defined for a Wi-Fi NAN as a mechanism for an application user to gather selected types of information about capabilities and services of other NAN devices.

An application may request Publish and Subscribe services to run in a certain type of NAN network, in any type of NAN network, or in all types of NAN networks. The NAN network type selection determines whether the discovered Publish and Subscribe services are intended to happen in isolated clusters, among the NAN devices that are close by, or among all the NAN devices that are within range of the NAN device. Network type selection, per NAN Discovery Engine service, is reflected in the lower levels of the NAN stack, handling the NAN network and cluster selection functions. When a Publish/Subscribe service has been configured to run in one type of network, corresponding functionality and discovery protocol message exchanges are made to happen only in a network of the same type. As discussed herein, the terms cell and cluster refer to the same thing.

Publish and Subscribe services are expected to exploit a discovery protocol that the NAN Discovery Engine implements and which are designed for NAN. The protocol is expected to have three different protocol messages: 1) Discovery query message, 2) Discovery response message, and 3) Discovery announcement message. The Subscribe service is expected to use the Discovery query message to conduct active discovery. The Subscribe service may be configured to operate in passive mode only. In this mode, no Discovery query messages are transmitted, but one listens for Discovery responses and Discovery announcement messages to find the information sought. The Publishing service is expected to use the Discovery response message and Discovery announcement message to announce availability of application-selected information to discovering devices. The Discovery response message is intended to be used as a response to a received Discovery query that meets response criteria. The Discovery announcement message is intended to be used to implement unsolicited Publishing service.

A device, in which the Subscribe service has been activated in active mode, transmits Discovery query messages to trigger Publishing devices to transmit Discovery response messages. In parallel, the Subscribing device monitors received Discovery responses and Discovery announcement messages to determine the availability of services and information being sought. Monitoring is envisioned to be a continuous process that applies to all Discovery response and Discovery announcement messages received while the Subscribe service is active. With this approach, a Subscribing device may gather valuable information from Discovery responses and from Discovery announcement messages that are independent from its own Discovery query message transmissions.

Each publish/service instance is given at least a service name (UTF-8 string) which identifies the service/application and which is used in the NAN Discovery Engine to generate a 6-octet service identifier (SID) value using a specified hash function. This SID is used as the primary matching criterion when looking for specific services. Thus this SID is transmitted in each publish and subscribe message to allow the message receiver to check whether a match occurs or not. Each publish/service instance may also be given further criteria for service discovery. This is called a matching filter. If a matching filter is given, the NAN Discovery Engine needs to use not only the SID for matching, but also the matching filter information is used. The basic idea is that there has to be a perfect match between both the SID and the matching filter from a publisher and from a subscriber in order to have success in discovery. Whenever a matching filter is given to the NAN Discovery Engine for subscribe/publish purposes, this matching filter is also carried along with the SID in subscribe/publish messages.

Additionally, each publish/service instance may be given service specific information that is not used in discovery, itself, and not in matching, but it is information that is communicated to the service/application layer in case of a SID/matching_filter match. Thus, this information is also carried in publish and subscribe messages to peer devices.

Both publish and subscribe messages are carried over the air in the form of a Service Descriptor Attribute. Each attribute represents one publish or subscribe instance and contains at least a SID and optionally matching filter and service specific information. Service Descriptor Attributes are carried in NAN Service Discovery Frames, which are vendor specific public action frames. A very limited amount of service discovery information may also be carried in NAN Beacon frames that may contain some of the NAN attributes in NAN information element (IE). One such an attribute is Service ID attribute that may contain a variable number of SIDs that may be set to indicate a selected set of published services. NAN Beacons and Service ID attributes within them may not be used for subscribe purposes, but one may indicate only published services and their SIDs.

MAC with NAN Support

The MAC is responsible for acquiring and maintaining time and frequency synchronization among devices that are close by, so that the devices are available for discovery protocol message exchange in same channel at same time. Synchronization happens through dedicated synchronization frames that are transmitted by so called master devices (on default) at the beginning of the availability periods. Sync frames are transmitted periodically in certain channels. Periodicity and channel usage is determined by sync frame parameters. Each device needs to be capable of acting as a master device and each device is expected to determine for each availability period whether it is a master device or not. This determination is done through a master election algorithm. The synchronization frames determine the schedule (time and frequency) of both the synchronization frame transmissions and the availability periods or discovery windows.

A NAN network is comprised of a set of NAN devices that operate under a common network identifier (NAN ID) and that share common sync frame and discovery window parameters. A NAN network comprises of one or more NAN clusters. Each NAN cluster may be a contention group or beacon group and may be considered a local representation of a NAN network. A NAN cluster is comprised of a set of NAN devices that operate in a NAN network with one NAN ID and which are synchronized with respect to both the sync frame transmissions and the discovery windows. In order for NAN devices to form a NAN cluster, at least some of them need to be within range of each other. The NAN ID is carried at least in synchronization frames that may be of a beacon frame format. Each beacon contains a NAN ID field that is used in a NAN device receiving a beacon, to determine, as an example, whether the beacon is from a NAN network in which the NAN device is operating and from what type of NAN network the beacon was transmitted. In one embodiment of the invention, the NAN ID is a numerical value that is indicated with a 6-octet field in beacons or in synchronization frames used in the NAN networks, to provide basic synchronization within NAN clusters. In one embodiment of the invention, there is no NAN cluster identifier that would be carried in beacon frames, but NAN cells are differentiated with different schedules especially from perspective of sync frame (beacon) schedule.

The NAN Discovery Engine leverages a variant of the Wi-Fi MAC which has features that have been specifically developed to allow low power discovery directly between devices within range. This MAC with NAN support provides synchronization in addition to frame transmit and receive services. The objective of the synchronization is to make all the NAN devices within range available for service discovery exchange at same time on same frequency channel. The synchronization builds upon Beacon frame transmissions in which all the NAN devices are involved. Beacon frames are transmitted periodically and they serve also as NAN network instance identifiers for devices that look for NAN network instances (NAN cluster is a NAN network instance). A NAN device which looks for a NAN network instance uses traditional Wi-Fi passive scanning by listening for Beacon frames from NAN devices. Typically a NAN device performs passive scanning once in 10-20 seconds and each scan lasts 200-300 ms each. Once a NAN device finds out one or more NAN network instances, it selects the instance to which it synchronizes and starts operating in.

A NAN Concurrent Device is a NAN Device that is capable of operating in a NAN network and other types of Wi-Fi networks, such as WLAN infrastructure, IBSS, and Wi-Fi Direct.

Basic Principles of NAN Operations:
Upon activating the NAN functions in a device, the device first looks for a NAN network by means of passive discovery. The NAN functions are activated by an application in the device requesting either the Subscribe or the Publish service to be activated, when there is no service active in the NAN Discovery Engine.
   a) On default there is at least one NAN ID that is determined in a NAN specification and the NAN device looks for such a network and its clusters.
Joining a NAN network/NAN cluster: If the device finds at least one NAN cluster that the device may join, the device selects a cluster and joins it. If the device finds no NAN cluster that the device may join, the device establishes a NAN cluster of its own. An application may have also requested the Publish service to be activated in a passive mode. In such case the device doesn't ever establish a NAN cluster, but it only operates in NAN clusters that have been established by others.
   a) A NAN device may join a NAN cluster when the following criterion is met:
      1. The device receives at least one sync frame from the cluster with signal level exceeding a pre-determined threshold RSSI_C (e.g. −50 dBm).
Upon joining a NAN cluster a NAN device synchronizes itself both to the sync frame transmission and discovery window schedule of the cluster.
   a) Additionally, the device is responsible for running the master election algorithm to determine whether it is a master device that is responsible for transmitting a sync frame.
Once in a NAN cluster, a NAN device may continue operating in it, as long as one of the following criteria is met:
   a) The device receives at least one sync frame from the cluster with signal level exceeding a pre-determined threshold RSSI_C (e.g. −50 dBm).
   b) The device operates as a master device transmitting sync frames.
When operating in a NAN cluster, a NAN device is responsible for maintaining both the base clock of the cluster by transmitting sync frames as needed and the discovery window schedule of the cluster.
Additionally, a NAN device is responsible for conducting passive discovery once a while to figure out whether there are other NAN clusters within range that that the device should consider joining
   a) When a NAN device detects a sync frame of a NAN cluster different from the one in which the device operates, but both the clusters belong to the NAN network the device operates in, and the sync frame is received with signal level exceeding a pre-determined threshold RSSI_C (e.g. −50 dBm), the device proceeds as follows:
      1. If the sync frame from the foreign cluster contains parameter values that indicate preference of the foreign cluster over one's own cluster, the device moves its operations to the foreign cluster.
      2. Otherwise the device continues its operations in the current cluster.

Neighbor Awareness Networking Network
A NAN network is comprised of a set of NAN devices that operate under a common network identifier (NAN ID) and that share common sync frame and discovery window parameters.
A NAN network is comprised of one or more NAN clusters.
In accordance with an example embodiment of the invention, two NAN network types are defined:
   a) Network of synchronized clusters.
   b) Network of isolated clusters.
Network identifier (NAN ID) depends on the network type.
   a) In a preferred implementation the NAN specification determines at least two NAN ID values and for each ID value the specification also determines the network type.
The network type determines whether discovery window schedules are aligned across cluster borders (network of synchronized clusters) or whether discovery window schedules are local to the cluster with the objective to especially keep adjacent/overlapping clusters unsynchronized from the perspective of discovery windows.
   a) In a network of synchronized clusters, the objective is to maximize use of one and same discovery window schedule.
   b) In a network of isolated clusters, the objective is to keep the clusters operating with their own discovery window schedules, so that only those devices that operate in same cluster are available for NAN discovery frames at a same time, in a same channel.

Cluster

A set of NAN devices that operate in a NAN network with one NAN ID and that are synchronized with respect to both the sync frame transmissions and the discovery windows form a NAN cluster.

In order for NAN devices to form a NAN cluster, at least some of them need to be within range of each other.

Synchronization within a NAN cluster means that the devices share the burden of sync frame transmission and are available simultaneously for NAN discovery during discovery windows.

Depending on whether a cluster belongs to a network of synchronized clusters or to a network of isolated clusters, the NAN devices moving from a cluster to another have certain obligations that are discussed in more detail later.

Sync Frames

Sync frames form the basis of time and frequency synchronization in the NAN network. All the NAN devices are responsible for participating in sync frame transmission, as per master role selection rules.

Sync frames are transmitted as per sync frame parameters that determine how often and in which channel(s) the frames are transmitted.

Sync frames provide a base clock for NAN devices and the base clock is used as the reference when specifying the discovery window schedule.

The base clock builds upon the time synchronization function (TSF) that is used in WLAN, and each sync frame is expected to contain a TSF timestamp value indicator.

A sync frame may be realized as a Beacon frame.

Discovery Window

A discovery window is a time period during which NAN devices are available for NAN discovery frame exchange.

Discovery windows happen as per discovery window parameters that determine how often and in which channel(s) the windows happen.

Discovery window schedule builds upon the information available in sync frames.

Discovery window schedule may be NAN cluster specific or same across NAN cluster borders depending on the NAN network type.

Both NAN Synchronization Beacons and NAN Service Discovery Frames are transmitted during Discovery Windows. The time and channel on which NAN Devices converge is called Discovery Window. Each discovery windows is 16 TUs (1.024 ms) long and time difference between start times of two consecutive DWs is 512 TUs. The assumption is that only NAN Discovery Beacons are transmitted outside the DWs.

Discovery Windows shall happen in the 2.4 GHz and specifically in channel 6. NAN Devices may also use the 5 GHz for NAN operation. If they do so, they schedule separate discovery windows for 2.4 GHz and 5 GHz. The 2.4 GHz DW schedule is, however, the basis of 5 GHz discovery window schedule. 5 GHz discovery windows will be equal in size with the ones in 2.4 GHz and in both bands the discovery window period is 512 TUs. The first discovery window in 5 GHz band is in offset of 128 TUs from the first discovery window in the 2.4 GHz band.

A NAN network comprises all NAN Devices that share a common set of NAN parameters that include: the time period between consecutive DWs, the time duration of the DWs, the beacon interval, and NAN channel(s). A NAN Cluster is a collection of NAN devices that share a common set of NAN parameters and are synchronized to the same DW schedule. A NAN Cluster is identified with the NAN Cluster identifier (ID). NAN devices that are part of the same NAN Cluster participate in the NAN Master selection procedure. That means in practice that each NAN device that operates in a NAN Cluster is responsible for participating in beaconing in the NAN Cluster.

Device Operations in a NAN Network

Upon activating the NAN in a device, the device first looks for a NAN network by means of passive discovery.

On default, there is one default NAN ID that is determined in a NAN specification and the NAN device looks for such a network and its clusters.

Joining a NAN network/NAN cluster:

If the device finds at least one NAN cluster that the device may join, the device selects a cluster and joins it.

If the device finds no NAN cluster that the device may join, the device establishes a NAN cluster of its own. If the NAN Discovery Engine has been requested to activate the Subscribe service in a passive mode, the device may also decide not to establish a NAN cluster of its own, but it only operates in NAN clusters it discovers.

When a NAN device operates in a NAN cluster, it periodically conducts passive discovery to find out whether other NAN clusters of the NAN network in which the device operates, are available.

Joining a NAN Cluster

A NAN device may join a NAN cluster when the following criterion is met:
The device receives at least one sync frame from the cluster with signal level exceeding a pre-determined threshold RSSI_C (e.g. −50 dBm).

Upon joining a NAN cluster, a NAN device synchronizes itself both to the sync frame transmission and discovery window schedule of the cluster.

Additionally, the device is responsible for running the master election algorithm to determine whether it is a master device that is responsible for transmitting a sync frame.

Operating in a NAN Cluster

A NAN device may continue operating in a NAN cluster as long as one of the following criteria is met:
The device receives at least one sync frame from the cluster with signal level exceeding a pre-determined threshold RSSI_C (e.g. −50 dBm).
The device operates as a master device transmitting sync frames.

When operating in a NAN cluster, a NAN device is responsible for maintaining both the base clock of the cluster by transmitting sync frames as needed, and the discovery window schedule of the cluster.

Master Election

In accordance with an example embodiment of the invention, a node, device, or STA may operate in one of two roles: As a Master Sync STA, it competes with other Master STAs to transmit a Beacon. As a Non-Master Sync STA, it does not compete to transmit a Beacon. The Master Sync STA role may be determined by the Master Election Algorithm for Neighbor Awareness Networking. Every node, device, or STA of an ad hoc network may need to be able to operate in both roles and the Master Election Algorithm may need to be run by every node, device, or STA once in a while or periodically.

A NAN device that operates in a NAN cluster may need to be responsible for determining for each discovery window, as per the master election algorithm, whether it is a master device.

A Sync Frame from a Foreign Cluster

When a NAN device detects a sync frame of a NAN cluster different from the one in which the device operates, but both the clusters belong to the NAN network the device operates in, and the sync frame is received with signal level exceeding a pre-determined threshold RSSI_C (e.g. −50 dBm), the device proceeds as follows:
If the timestamp (e.g. TSF value) in the sync frame from the foreign cluster is larger than the time in one's own cluster, the device moves its operations to the foreign cluster.
Alternatively some other information in the sync frame from the foreign cluster is analyzed to determine whether the device moves its operations to the foreign cluster.
Otherwise the device continues its operations in the current cluster.

Moving Operations to a New Cluster

When a NAN device operates in a network of synchronized clusters, it shall do as follows when moving its operations to a new cluster upon detecting the existence of the new cluster through passive discovery:

a) If the device is a master device in the current/old cluster, the rules are as follows:
The device transmits as a master device in the current/old cluster at least one sync frame that contains information about the new cluster. This includes information at least about TSF value and discovery window schedule of the new cluster.
Once the device has transmitted at least one sync frame in the current/old cluster with information about the new cluster, it shall start operating in the new cluster and ceases all the operations in the old cluster.

b) If the device is a non-master device in the current/old cluster, the rules are as follows:
The device shall start operating in the new cluster and ceases all the operations in the old cluster.

When a NAN device operates in a network of isolated clusters, it shall do as follows when moving its operations to a new cluster:

a) Regardless of whether the device is a master or a non-master device in the current/old cluster, the device shall start operating in the new cluster and ceases all the operations in the old cluster.

Aligning Discovery Window Schedules

When a NAN device operates in a network of synchronized clusters, it shall do as follows upon detecting the existence of the new cluster from a received sync frame that contains information about the new cluster and the new cluster is indicated to be the one whose discovery window is to be used:

a) If the device is a master device in the current/old cluster, the rules are as follows:
The device may transmit as a master device in the current/old cluster at least one sync frame that contains information about the new cluster.
The device starts using the discovery window schedule of the new cluster.
The device may activate passive discovery to find out whether it can detect the new cluster and whether it can receive sync frames from the new cluster with high enough signal level in order to synchronize from perspective of sync frame transmissions.

b) If the device is a non-master device in the current/old cluster, the rules are as follows:
The device starts using the discovery window schedule of the new cluster.
The device may activate passive discovery to find out whether it can detect the new cluster and whether it can receive sync frames from the new cluster with high enough signal level in order to synchronize from perspective of sync frame transmissions.

D. Inter-AP Communication Within Neighbor Awareness Networking

In accordance with an example embodiment, the invention may be used in the logical architecture of Neighbor Awareness Networking (NAN).

In an example embodiment of the invention, a WLAN AP may include two WLAN interfaces: one for normal infrastructure AP usage and another for NAN based communication with other APs. The NAN interface provides support for inter-BSS synchronization and communication through the basic operation of NAN cluster, and it is the basis of an inter-AP communication channel.

In an example embodiment of the invention, the access point devices are each capable of concurrently operating in a wireless network, such as a Wi-Fi network, as an access point responsible for coordinating communication in their respective wireless networks and also participating in the neighbor awareness network cluster.

In an example embodiment of the invention, after the NAN cluster is set-up, the NAN is used as the communication channel between the APs. The NAN service discovery (i.e. NAN Service Discovery Frame communication during NAN Discovery Windows) may be used to establish the inter-AP communication channel.

In an example embodiment of the invention, the inter-AP communication channel may be used as an inter-AP communication service that shares short pieces of related information between the APs in NAN Service Discovery Frames transmitted during the NAN Discovery Windows. In general, there is one inter-AP communication service, which may be further split into sub-services. On default, a Service ID in the NAN Service Discovery Frame may be used as the identifier of the “base” service and the identifiers of the sub-services are carried in other fields, such as a Matching Filter. If the Matching Filter is not used, possible sub-service identifiers may be carried in the Service Info field.

In another example embodiment of the invention, the inter-AP communication channel may be used as an inter-AP control channel that exchanges control information between the APs. In general, there is one inter-AP control channel, which may be further split into sub-channels. All these sub-channels may be made available for control services, and each may either run over a channel dedicated for the control service or share a common control channel. The NAN data path may be used for control plane messages that may not be fit into the service discovery frames. In general, the NAN data path may be used for any control plane communication that has e.g. latency, delay, or bit rate requirements that cannot be met with the NAN service discovery frames. The control channel may be divided into logical control services for different purposes and the APs interested in each logical control service may then listen to the respective service.

In example embodiments of the invention, alternate wireless network technologies, besides the Wi-Fi network technology based on the IEEE 802.11 standard, may be used to implement access points that are responsible for coordinating communication in the alternate wireless network, and composing a service ID indicating support for communication with other access point devices operating in a second neighbor awareness network. The access point device in such alternate wireless network technologies, would be capable of concurrently operating as an access point in the alternate wireless network and participating in the second neighbor awareness network. The access point device in such alternate wireless network technologies, would be capable of transmitting a wireless service discovery frame to the second neighbor awareness network, the service discovery frame including the composed service ID.

Examples of such alternate wireless network technologies include, for example short range networks such as Bluetooth™, Bluetooth™ Low Energy, Zigbee, Digital Enhanced Cordless Telecommunications (DECT), HiperLAN, Radio Frequency Identification (RFID), Wireless USB, DSRC (Dedicated Short Range Communications), Near Field Communication, wireless sensor networks, EnOcean; TransferJet, and Ultra-wideband (UWB from WiMedia Alliance).

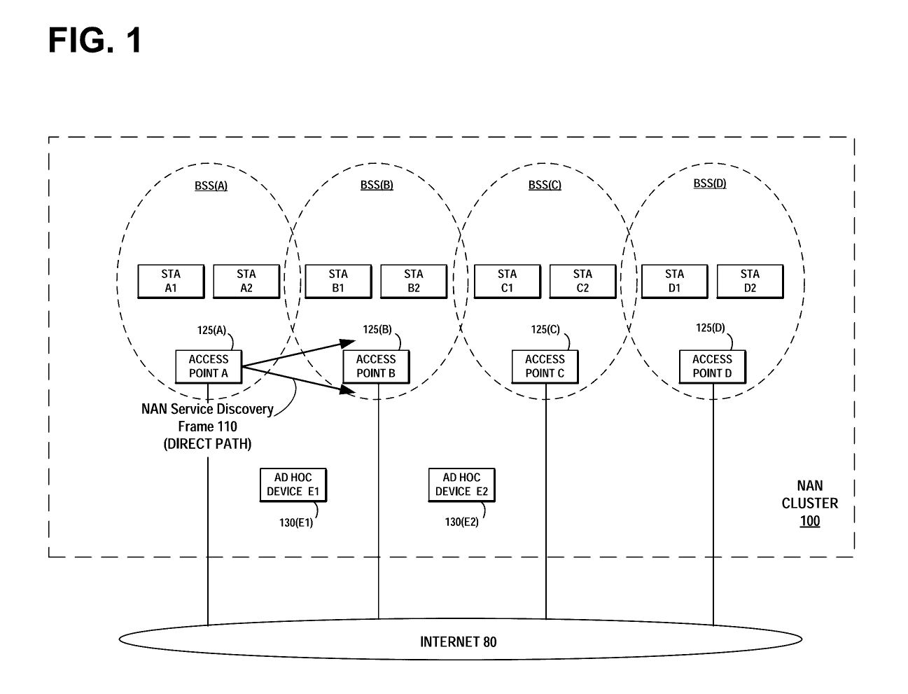

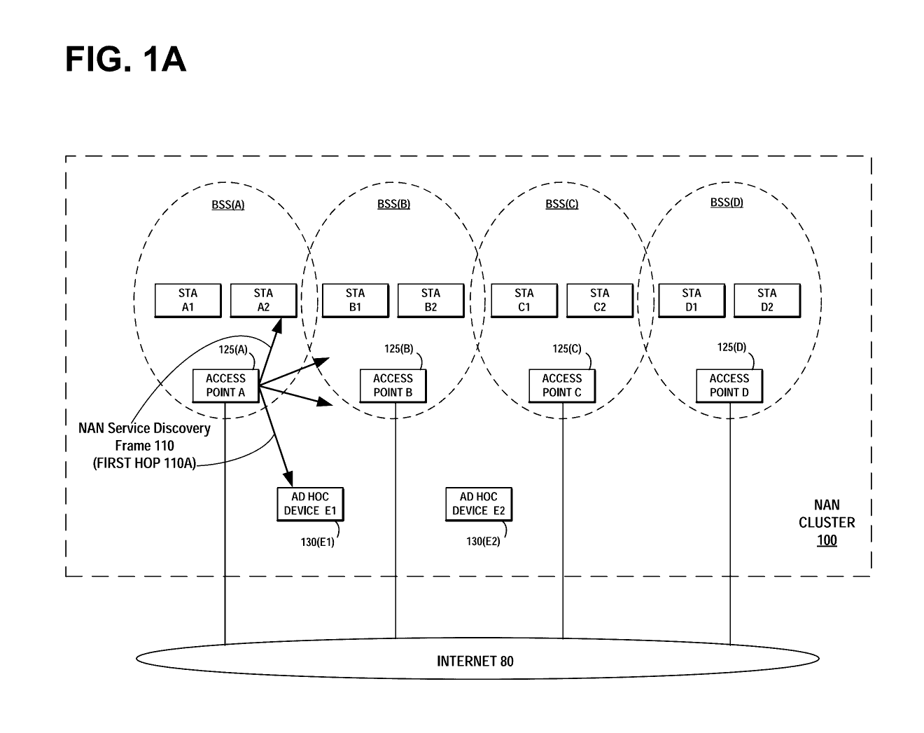

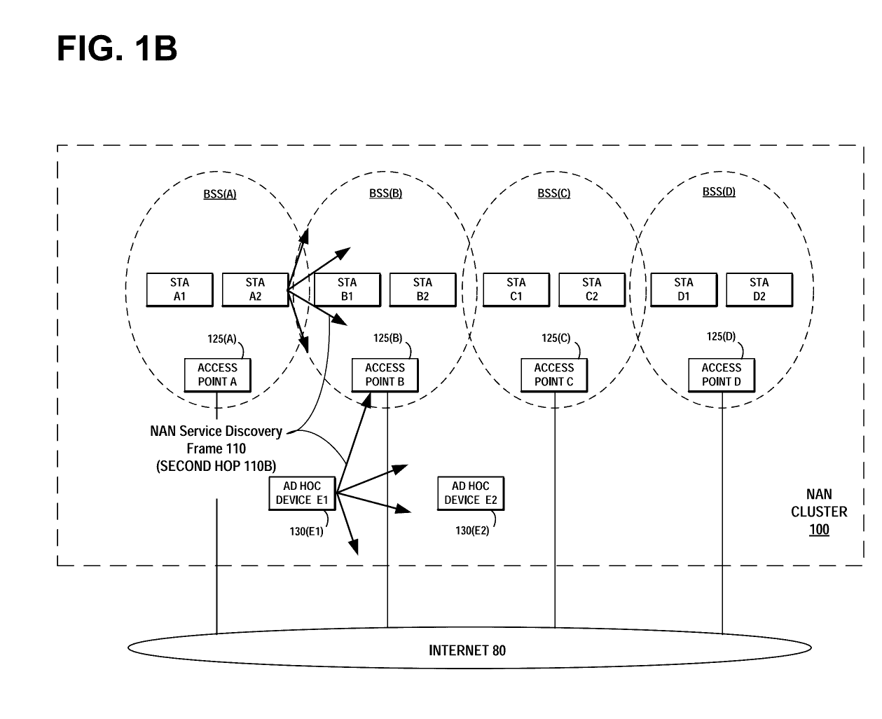

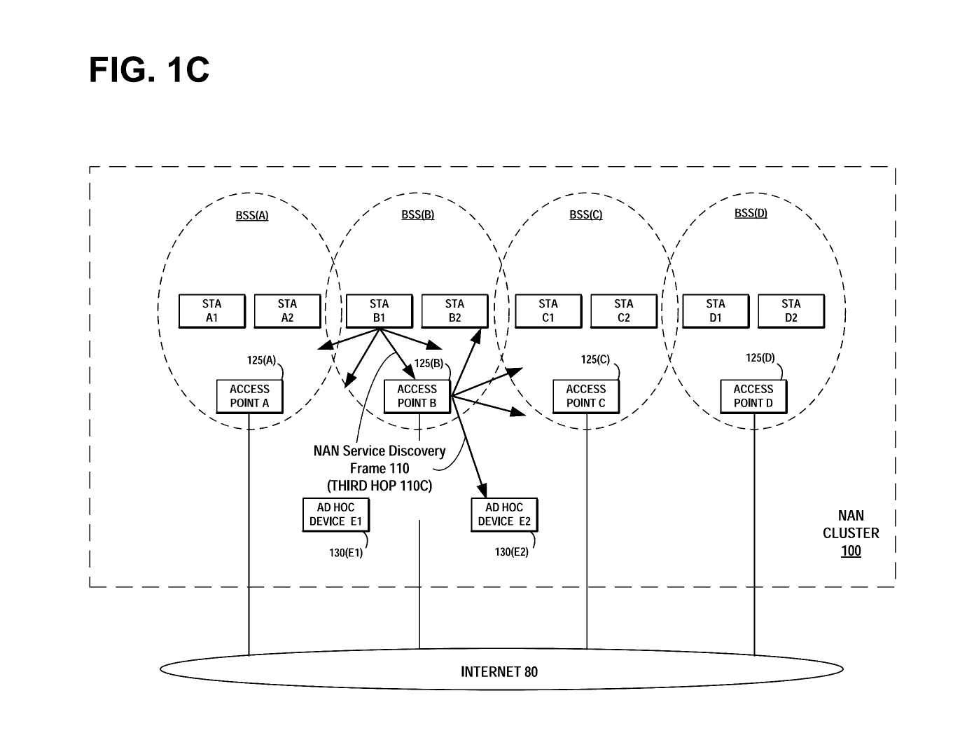

FIG. 1 illustrates an example network diagram of a plurality of access point devices A, B, C, and D, identified respectively as 125(A), 125(B), 125(C), and 125(D), which are operating in a neighbor awareness network cluster 100. The access point devices A, B, C, and D are each capable of concurrently operating in a wireless network, such as a Wi-Fi network, as an access point responsible for coordinating communication in their respective wireless networks and also participating in the neighbor awareness network cluster. In the example shown, the NAN service discovery frame 110 is broadcast by the access point device A. The access points A and B are close enough to wirelessly communicate directly with each other by means of the NAN, such that the nearest APs can hear each other. The service discovery frame 110 includes a service ID indicating support for synchronization and communication with other access point devices in the cluster, in accordance with at least one embodiment of the present invention.

The figure shows the NAN service discovery frame 110 completing the direct transmission from access point device A to access point device B. This is referred to as being through the operation of the neighbor awareness network cluster. The APs use the NAN service discovery mechanisms (publish and subscribe) to establish a communication channel for inter-AP communication, in accordance with at least one embodiment of the present invention.

FIG. 1A illustrates an example network diagram of a plurality of access point devices A, B, C, and D, identified respectively as 125(A), 125(B), 125(C), and 125(D), and two ad hoc devices E1 and E2, identified respectively as 130(E1) and 130(E2), which are operating in a neighbor awareness network cluster 100. The access point devices A, B, C, and D are shown connected, either wired or wirelessly, to the Internet 80. The ad hoc devices E1 and E2 are not associated to an access point, but are operating in the neighbor awareness network cluster 100. Access point device A manages the BSS(A) and STAs A1 and A2 are associated with the access point A. Access point device B manages the BSS(B) and STAs B1 and B2 are associated with the access point B. Access point device C manages the BSS(C) and STAs C1 and C2 are associated with the access point C. Access point device D manages the BSS(D) and STAs D1 and D2 are associated with the access point D.

The figure shows one of the access point devices, A, transmitting a broadcast wireless service discovery frame 110 to any devices in the cluster, including the other access point devices B, C, and D and the ad hoc devices E1 and E2 in the cluster 100. The NAN service discovery frame 100 includes a service ID indicating support for synchronization and communication with other access point devices in the cluster, in accordance with at least one embodiment of the present invention.

In an example embodiment of the invention, APs use the NAN service discovery mechanisms (publish and subscribe) to establish a communication channel for inter-AP communication. Whenever an AP intends to use the NAN for inter-AP communication it uses publish/subscribe services in the NAN with a predefined service name, e.g. “org.wifi.interAPcomm”. Publish/subscribe messages carried in the NAN Service Discovery Frames may be used also to convey some basic information about the AP. That information should not be encrypted except in case of enterprise scenario, where the information might be encrypted on the application level, if wanted.

Since other access point devices B, C, and D that are sought to be discovered in the cluster 100, may not be within direct range of the transmitting access point device A, the transmitting access point A may rely on any other devices within range in the cluster, to rebroadcast the NAN service discovery frames, so as to reach one or more access point devices in the cluster. This is referred to as being through the operation of the neighbor awareness network cluster.

In the example shown in FIG. 1A, the NAN service discovery frame 110 is broadcast as the first hop 110A, by the access point device A. The first hop 110A of the NAN service discovery frame 110 is able to reach the STA A2 that is associated to the access point device A, and also to reach the ad hoc device E1 that is not associated to the access point device A, but which is operating in the neighbor awareness network cluster 100. The first hop 110A of the NAN service discovery frame 110 is also able to reach the nearest access point device B in the cluster 100.

FIG. 1B illustrates the example network diagram of FIG. 1A, wherein two indirect paths may be to be available for the NAN service discovery frame 110 to reach the nearest access point device B in the cluster 100, either via the ad hoc device E1 in one additional hop or via the STA A2 in two additional hops. The figure shows the second hop 110B of the NAN service discovery frame 110 being retransmitted by the STA A2 to the STA B1 that is associated to the next closest access point device B. The figure also shows the second hop 110B of the NAN service discovery frame 110 being retransmitted by the ad hoc device E1 to the next closest access point device B, completing the indirect transmission from access point device A to access point device B in two hops. This is referred to as being through the operation of the neighbor awareness network cluster.

FIG. 1C illustrates the example network diagram of FIG. 1B, wherein the third hop 110C of the NAN service discovery frame 110 being retransmitted by the STA B1 to the next closest access point device B, completing the indirect transmission from access point device A to access point device B in three hops. This is referred to as being through the operation of the neighbor awareness network cluster.

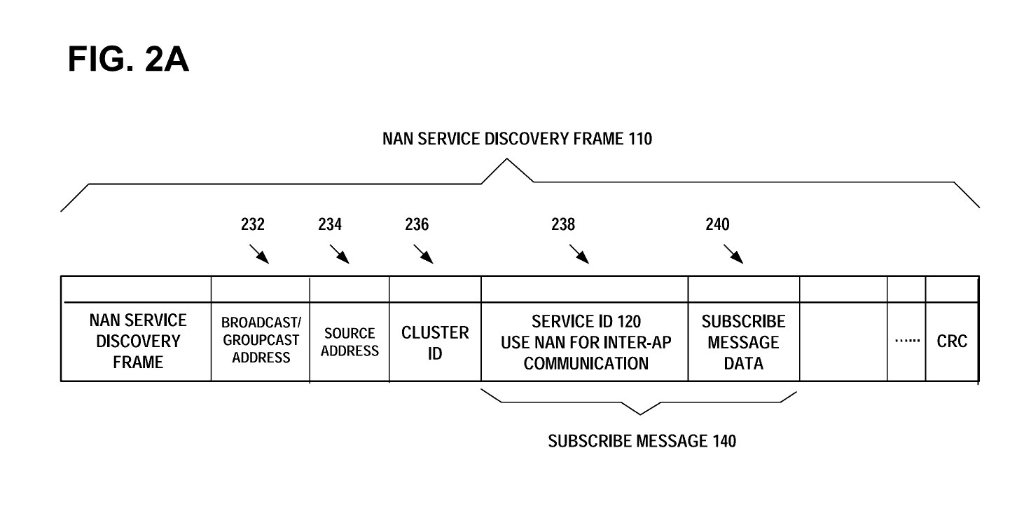

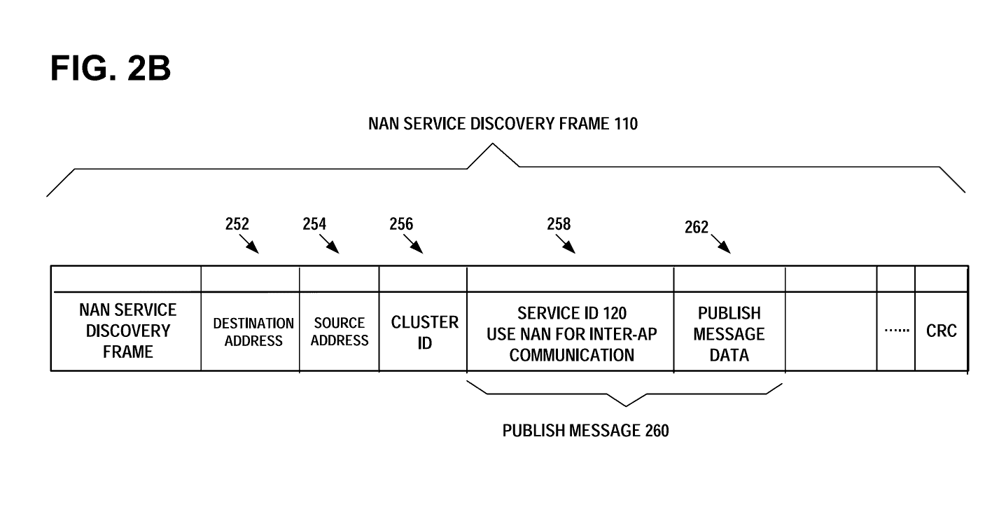

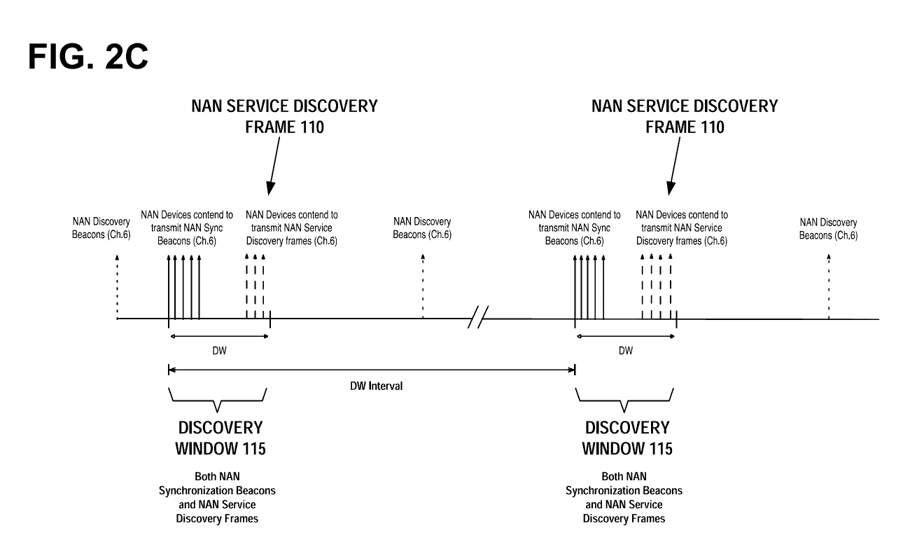

FIG. 2A shows an example format of a NAN service discovery frame 110 used to carry information about the subscribed service. The figure shows the subscribe message 140 within the NAN service discovery frame 110, which includes the service ID 120 indicating support for synchronization and communication with other access point devices in the cluster, in accordance with at least one embodiment of the present invention.

The NAN service discovery frame is used to carry information about the subscribed service. A NAN service discovery frame may contain any number of publish or subscribe messages within constraints of the frame size limitations. The NAN service discovery frame includes fields for broadcast or groupcast address 232, source address 234, and cluster ID 236. This is followed by a variable number of publish or subscribe messages. The figure shows the subscribe message 140 within the NAN service discovery frame. The subscribe message 140 includes the service ID 120 indicating support for synchronization and communication with other access point devices in the cluster. The subscribe message data 240 may include service_name, matching_filter_rx, matching_filter_tx, service_specific_info, and configuration_parameters. A service discovery frame may include one or more subscribe messages 140.

The NAN Service Discovery Frame 110 is an IEEE 802.11 management frame that may include fields for Frame Control, Duration, Receive address (NAN Network ID), Transmit address, Cluster ID, Sequence Control, HT Control (presence indicated with the Frame Control), the NAN Service Discovery Frame Body, and a cyclic redundancy code (CRC). The NAN Service Discovery Frame Body includes NAN attributes specifying, for example, service ID attributes and service descriptor attributes. A service descriptor attribute may be used in NAN Service Discovery Frame.

FIG. 2B shows an example format of a NAN service discovery frame 110 used to carry information about the published service. The figure shows the publish message 260 within the NAN service discovery frame 110, which includes the service ID 120 indicating support for synchronization and communication with other access point devices in the cluster, in accordance with at least one embodiment of the present invention.

The NAN service discovery frame is used to carry information about the publish service. A NAN service discovery frame may contain any number of publish or subscribe messages within constraints of the frame size limitations. The NAN service discovery frame includes fields for destination address 252, source address 254, and cluster ID 256. This is followed by a variable number of publish or subscribe messages. The figure shows the publish message 260 within the NAN service discovery frame 110. The publish message 260 includes the service ID 120 indicating support for synchronization and communication with other access point devices in the cluster, in accordance with at least one embodiment of the present invention. The publish message data 262 may include service_name, matching_filter_rx, matching_filter_tx, service_specific_info, and configuration_parameters. A service discovery frame may include one or more publish messages 340.

FIG. 2C illustrates an example Discovery Window 115 in 2.4 GHz, within which is transmitted the NAN Service Discovery frame 110, in accordance with an example embodiment of the invention.

During a discovery window 115, one or more NAN Devices transmit a NAN Service Discovery frame 110, which is a Vendor Specific Public Action frame. The NAN Service Discovery Frame 110 is an IEEE 802.11 management frame, transmitted by a NAN device in a NAN cluster. NAN Service Discovery frames 110 enable NAN Devices to look for services from other NAN Devices and make services discoverable for other NAN Devices. There are three NAN Service Discovery protocol messages defined in the NAN Service Discovery Protocol:

1. Publish message 260

2. Subscribe message 140

3. Follow-up message

The NAN Service Discovery protocol messages are carried in Service Descriptor attributes that are carried in the NAN Service Discovery frames 110. A NAN Device may use a NAN Service Discovery frame 110 to actively look for availability of a specific service. When a NAN Device uses a Subscribe message, it asks for other NAN Devices operating in the same NAN Cluster to transmit a Publish message when response criteria are met. A NAN Device may use a Publish message to make its service discoverable for other NAN Devices operating in the same NAN Cluster in an unsolicited manner. The Service Control field indicates if the Service Descriptor attribute corresponds to Publish, Subscribe, or Follow-up function and if other optional fields are present in the Service Descriptor attribute such as Matching Filter, Service Response Filter, and Service specific information.

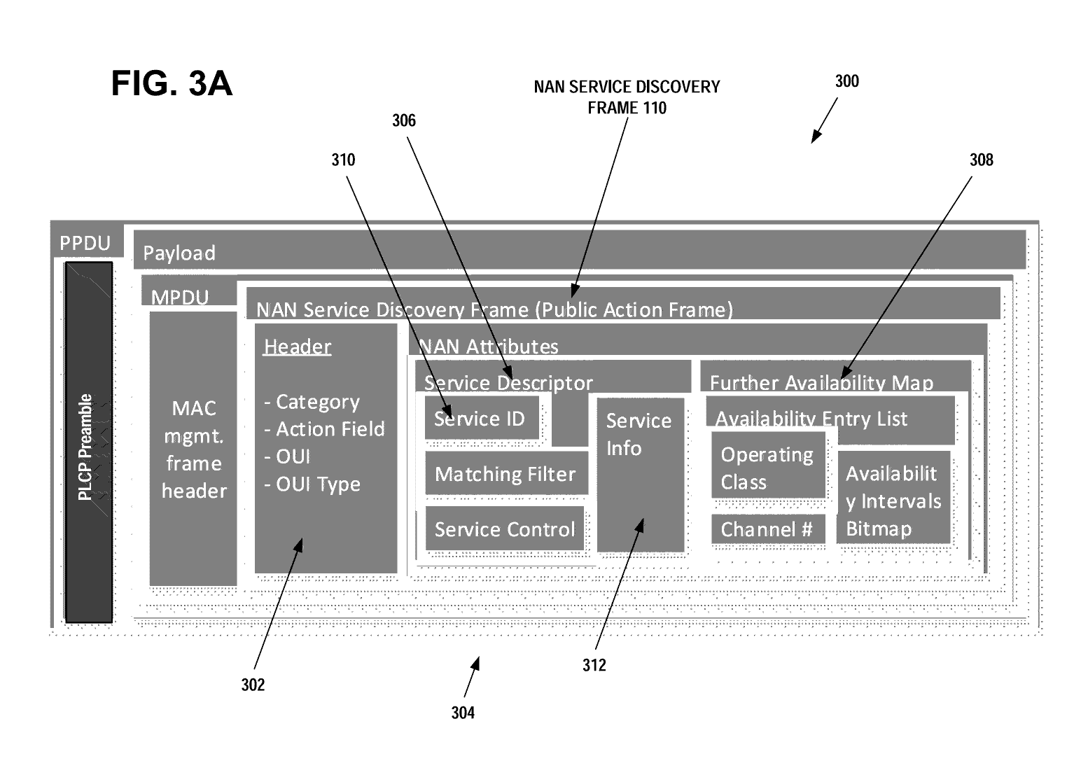

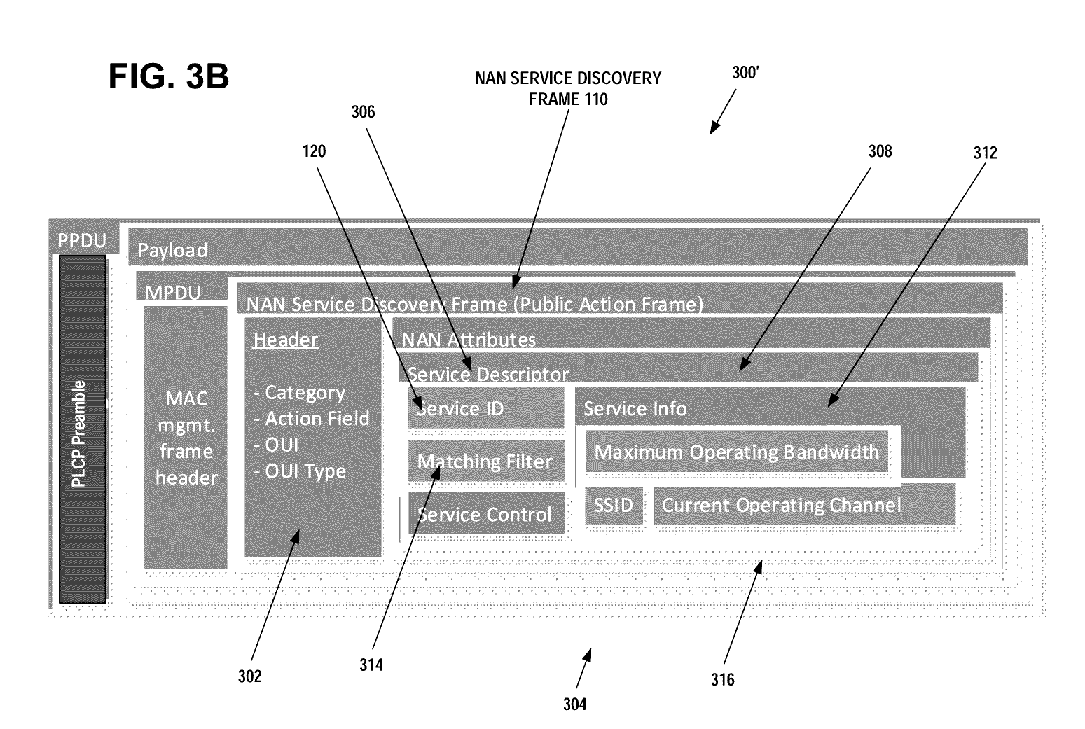

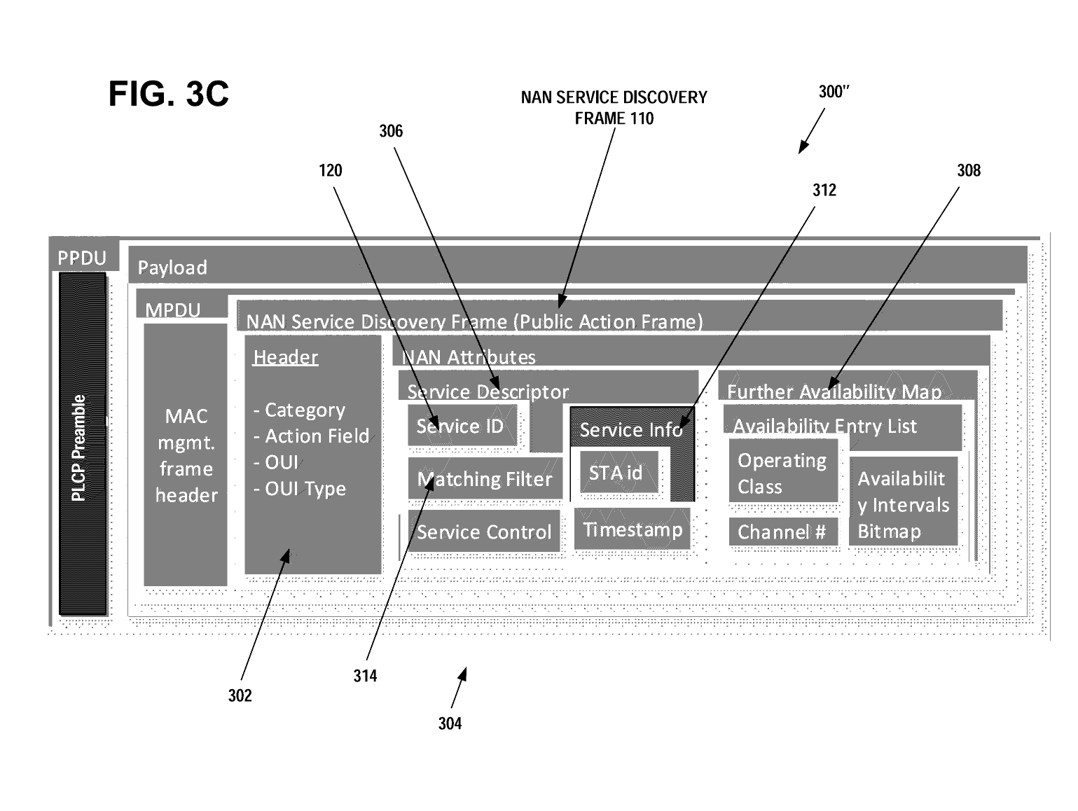

FIG. 3A shows an example format of the Basic NAN PDU structure 300, which includes the NAN Service Discovery frame 110, in accordance with an example embodiment of the invention. The figure presents a slightly simplified version of the basic NAN PDU structure. The action frame based NAN Service Discovery Frame 110 is the PDU used to publish, subscribe or follow-up a service. The PDU 110 contains a common header part 302 and set of NAN attributes 304. In this example, two NAN attributes are included: a Service Descriptor 306 and a Further Availability Map 308. Service Descriptor 306 is the only mandatory attribute and it describes the actual service and may also contain a Service Info field 312 that may be used to deliver any service specific information.

In an example embodiment of the invention, the Service ID 310 of the NAN Service Discovery frame 110 may be used to indicate availability of an inter-AP communication service. The Service ID 120 in the Service Descriptor 306 may be used as the identifier of the “base” service and the identifiers of the sub-services are carried in other fields like in the Matching Filter 314.

In another example embodiment of the invention, the Service ID 310 of the NAN Service Discovery frame 110 may be used to indicate availability of an inter-AP control channel that exchanges control information between the APs. The Service ID 120 in the Service Descriptor 306 may be used as the identifier of the “base” channel and the identifiers of the sub-channels are carried in other fields like in the Matching Filter 314.

FIG. 3B shows an example format of the NAN inter-AP channel usage reporting PDU structure 300′, which includes the NAN Service Discovery frame 110, in accordance with an example embodiment of the invention. The figure presents an exemplary structure of a PDU 300′ used for channel selection application. The fields specific for the invention are:
Service ID 120=“org.wifi.interAPcomm”
Matching Filter 314=“channelSelection”
Maximum Operating Bandwidth, SSID and Current Operating Channel 316 are set based on the active parameters in the infrastructure AP. Some quality and load information may also be added to the service info 312.

As a result, all the APs that are subscribed to the “org.wifi.interAPcomm” serviceID 120 and use “channelSelection” matching filter 314, shall get information related to channel selection on the other APs of the cluster. In addition, the APs may perform ranging with each other and include the distance information for the channel selection algorithm. In another implementation, the ServiceID may be set to indicate both the “base” service and the sub-service. In such an implementation the Service ID may be set to “org.wifi.interAPcomm.channelSelection” and the matchingFilter may be left out.

The message presented in FIG. 3B is used to share WLAN channel selection related information that may be used by the APs to select the best channel for themselves. In addition, another set of messages may be defined, to be used for requesting information, or requesting an action, such as channel switch.

FIG. 3C shows an example format of the NAN inter-AP handover signaling PDU structure 300″, which includes the NAN Service Discovery frame 110, in accordance with an example embodiment of the invention. In this case, the PDU 300″ may contain fields defined, as in the figure, wherein the Service ID 120 is again set to “org.wifi.interAPcomm”, the matching filter 314 set to “handover”, and the Service Info 312 contains information on which STA should perform the handover, and when should it be done.

After the normal WLAN handover has been performed, it may be that the old AP should forward the STA's queued downlink data packets for the new AP. For this purpose, the APs may agree on the Further Availability Map 308, which defines when and on which channel, they will be available for such data transmission. This may be performed in a way defined as NAN2 data path.

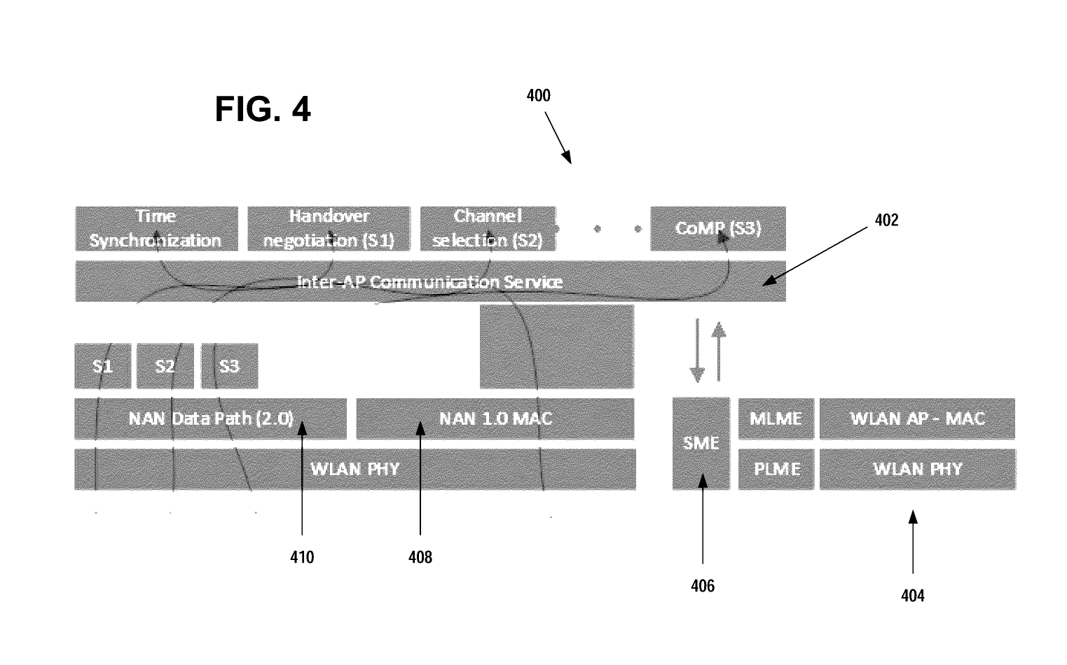

FIG. 4 shows an example of the protocol stack 400 of a WLAN AP implementing NAN inter-AP communication, in accordance with an example embodiment of the invention. The figure presents an exemplary protocol stack of WLAN AP, implementing NAN as inter-AP communication. Inter-AP communication service 402 uses NAN as a communication channel, and then controls the AP WLAN stack 404 using the Station Management Entity (SME) 406. SME on its behalf then controls the physical and MAC layers (MLME and PLME). The communication service 402 may also read/get information from form WLAN stack 404 using the SME 406.

Inter-AP Communication Service 402 is responsible for advertising the basic inter-AP communication facilities and logical sub-services of it. Some of the sub-services may utilize the only the NAN Service Discovery Frames transmitted during the NAN Discovery Windows provided by the first release of the NAN 408 (e.g. time synchronization) and some of them will use NAN data path 410 which will be available in the second release of the NAN (e.g. Handover negotiation (S1), channel selection (S2), and CoMP (S3)).

The protocol stack 400 enables the device to concurrently operate in a Wi-Fi network as an access point responsible for coordinating communication in its respective Wi-Fi network and also participate in the neighbor awareness network cluster.

APs belonging to the same NAN cluster, shall be synchronized with normal NAN operation. APs belonging to multiple NAN clusters may also exchange information between the clusters and that way extend the range of the information.

In an example embodiment of the invention, STAs may be configured, by e.g. the enterprise IT department, to relay the inter-AP related NAN service discovery messages to other NAN devices, like APs. In this way, the range of the inter-AP cluster may be extended. This kind of multi-hop NAN functionality is not an essential part of this invention, but such a feature may be utilized by this invention.

In case the AP is operating on the same channel as NAN (WLAN 2.4 GHz channel 6), the AP may also be implemented with only single radio. Otherwise, there might be some issues, related to simultaneous rx or tx of NAN and infra radios. The implementation of the device should be done so that this is possible, but the in-device interference might cause some instantaneous errors.

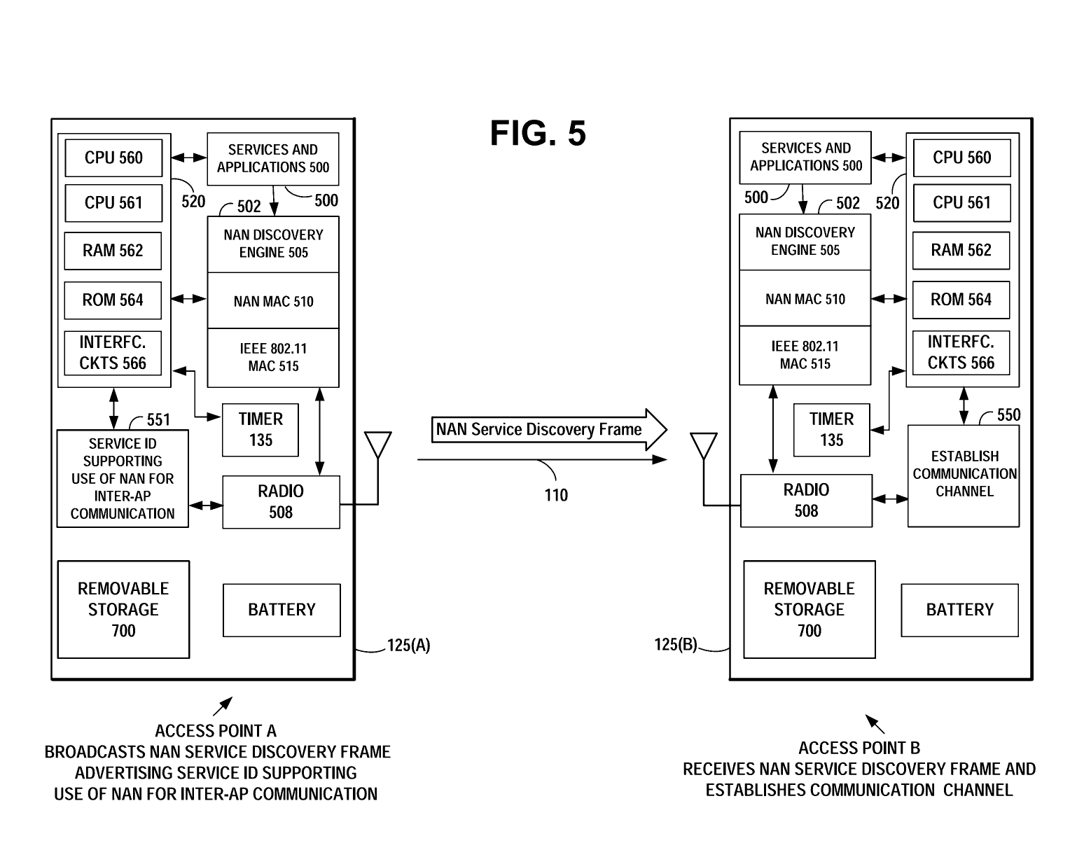

FIG. 5 illustrates an example network diagram of two neighbor access point devices A and B, identified respectively as 125(A) and 125(B), which are operating in a neighbor awareness network cluster 100. The access point devices A and B are each capable of concurrently operating in a wireless network, such as a Wi-Fi network, as an access point responsible for coordinating communication in their respective wireless networks and also participating in the neighbor awareness network cluster. The figure shows one of the access point devices, A, transmitting a wireless service discovery frame 110 to the other access point devices in the cluster 100. The service discovery frame 110 includes a service ID indicating support for synchronization and communication with other access point devices in the cluster, in accordance with at least one embodiment of the present invention.

Access point device A is shown broadcasting the NAN Service Discovery Frame packet 110 advertising the NAN identity (ID) of the publisher A. The access point device B is shown functioning as a NAN subscriber receiving the NAN Service Discovery Frame 110, in accordance with at least one embodiment of the present invention.

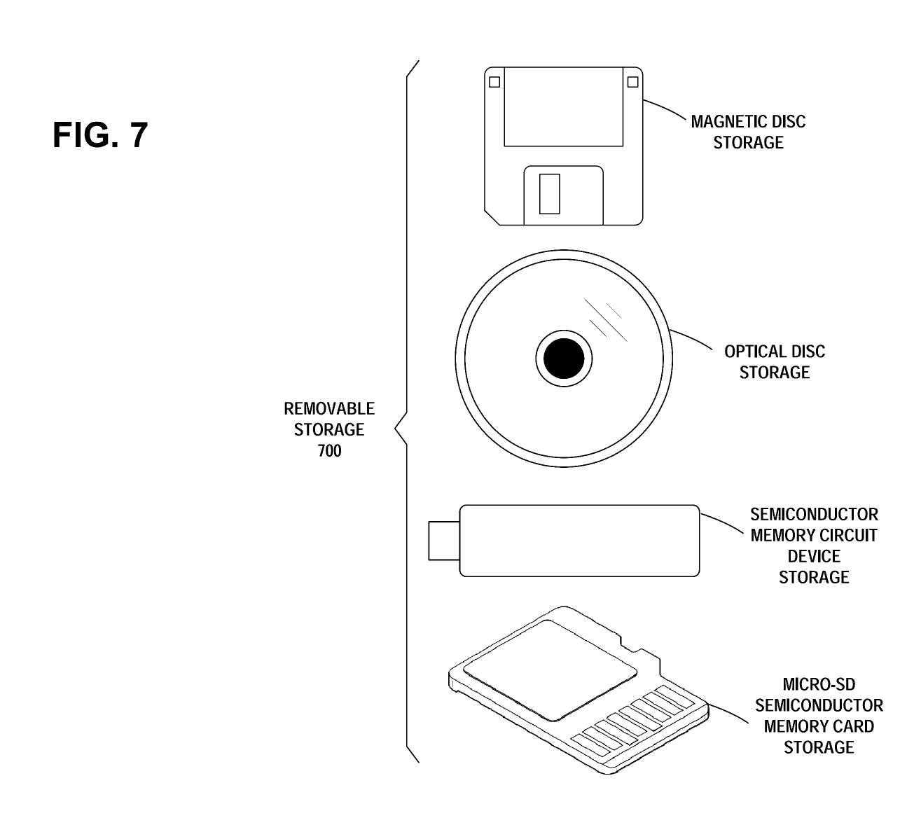

In an example embodiment of the invention, the access point A and the access point B may include a processor 520 that includes a single core or multi-core central processing unit (CPU) 560 and 561, a random access memory (RAM) 562, a read only memory (ROM) 564, and interface circuits 566 to interface with the radio transceiver 508. The access point A and the access point B may each further include a battery and other power sources, key pad, touch screen, display, microphone, speakers, ear pieces, camera or other imaging devices, etc. The RAM 562 and ROM 564 may be removable memory devices 700 shown in FIG. 7, such as smart cards, SIMs, WIMs, semiconductor memories such as RAM, ROM, PROMS, flash memory devices, etc. according to an embodiment of the present invention. According to an example embodiment of the invention, the access point A and the access point B, each include the awareness protocol stack 502.

In an example embodiment of the invention, the awareness protocol stack 502 may include the NAN discovery engine 505 and the NAN MAC 510. In an example embodiment of the invention, the awareness protocol stack 502 may include an Awareness Layer, Community Layer, Network Layer, and Link Layer. In an example embodiment of the invention, the awareness protocol stack 502 may include the IEEE 802.11 protocol stack 515.

In an example embodiment of the invention, the processor 520, protocol stack 502 and/or application program 500 may be embodied as program logic stored in the RAM 562 and/or ROM 564 in the form of sequences of programmed instructions which, when executed in the CPUs 560 and/or 561, carry out the functions of the disclosed embodiments. The program logic may be delivered to the writeable RAM, PROMS, flash memory devices, etc. 562 of the access point A and the access point B from a computer program product or article of manufacture in the form of computer-usable media such as resident memory devices, smart cards or other removable memory devices, as illustrated in FIG. 7. Alternately, they may be embodied as integrated circuit logic in the form of programmed logic arrays or custom designed application specific integrated circuits (ASIC). The radio 508 in the each of the access point A and the access point B may be separate transceiver circuits or alternately, the radio 508 may be a single radio module capable of handling one or multiple channels in a high speed, time and frequency multiplexed manner in response to the processor 520. The program code for instructing the apparatus to perform its various operations may be stored in computer readable media, for example magnetic disks, CD ROMS, or flash memory devices. The program code may be downloaded from such computer readable media to be stored for example in the RAM 562 or programmable ROM 564 of the access point A and the access point B for execution of the program code for example by the CPUs 560 and/or 561. Removable storage media 700 are shown in FIG. 7.

In an example embodiment of the invention, the access point device A composes the service ID indicating support for synchronization and communication with other access point devices in the cluster and buffers it in the buffer 551. The access point device A then transmits the service discovery frame 110 to other access point devices in the cluster, the service discovery frame including the service ID. The access point device B receives the wireless service discovery frame 110, including a service ID indicating support for synchronization and communication with access point devices in the cluster. In response to receiving the wireless service discovery frame 110, the access point device B establishes a communication channel 550 with the access point device A, through operation of the neighbor awareness network cluster 100.

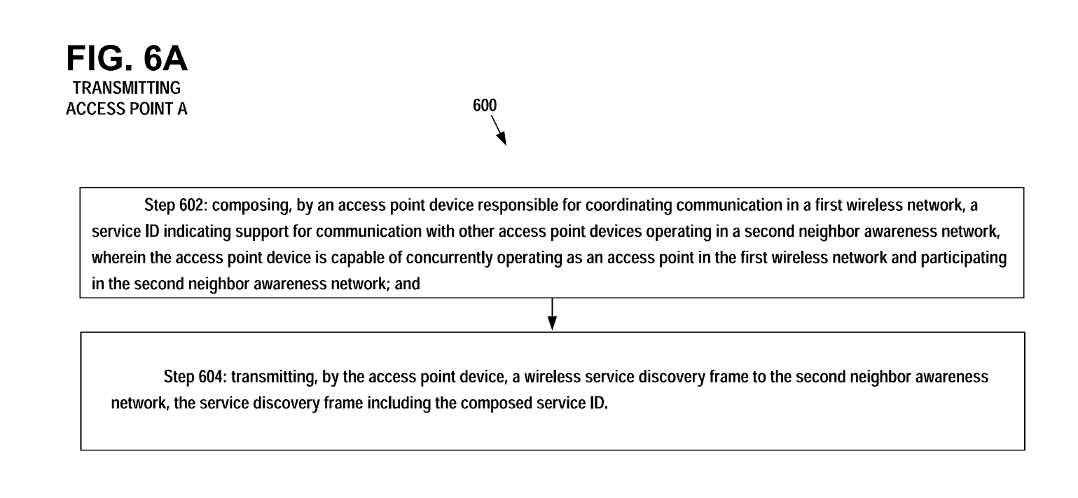

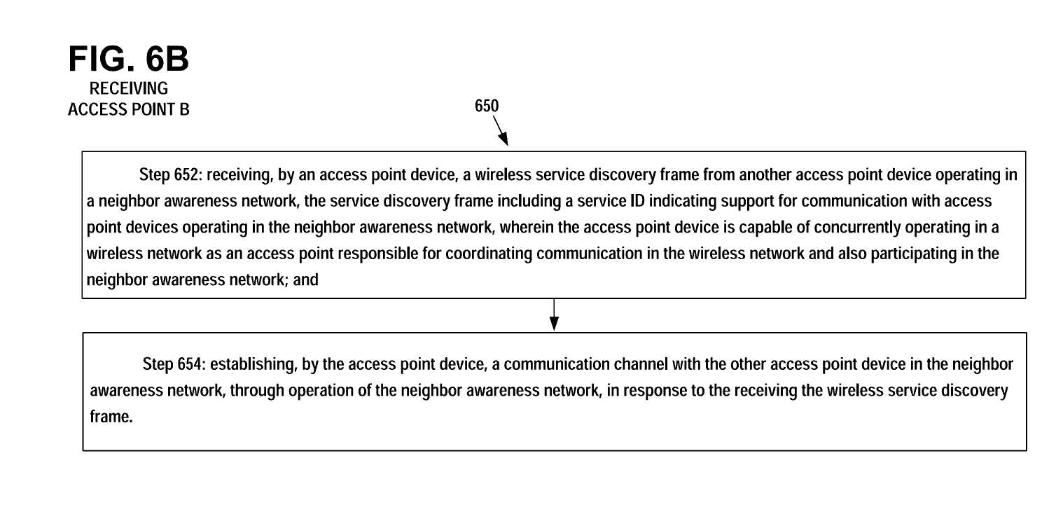

FIG. 6A is an example flow diagram 600 of operational steps in either the transmitting access point A, in accordance with at least one embodiment of the present invention. The steps of the flow diagram represent computer code instructions stored in the RAM and/or ROM memory, which when executed by the central processing units (CPU), carry out the functions of the example embodiments of the invention. The steps may be carried out in another order than shown and individual steps may be combined or separated into component steps. The flow diagram has the following steps:

Step 602: composing, by an access point device responsible for coordinating communication in a first wireless network, a service ID indicating support for communication with other access point devices operating in a second neighbor awareness network, wherein the access point device is capable of concurrently operating as an access point in the first wireless network and participating in the second neighbor awareness network; and

Step 604: transmitting, by the access point device, a wireless service discovery frame to the second neighbor awareness network, the service discovery frame including the composed service ID.

FIG. 6B is an example flow diagram 650 of operational steps in either the receiving access point B, in accordance with at least one embodiment of the present invention. The steps of the flow diagram represent computer code instructions stored in the RAM and/or ROM memory, which when executed by the central processing units (CPU), carry out the functions of the example embodiments of the invention. The steps may be carried out in another order than shown and individual steps may be combined or separated into component steps. The flow diagram has the following steps:

Step 652: receiving, by an access point device, a wireless service discovery frame from another access point device operating in a neighbor awareness network, the service discovery frame including a service ID indicating support for communication with access point devices operating in the neighbor awareness network, wherein the access point device is capable of concurrently operating in a wireless network as an access point responsible for coordinating communication in the wireless network and also participating in the neighbor awareness network; and

Step 654: establishing, by the access point device, a communication channel with the other access point device in the neighbor awareness network, through operation of the neighbor awareness network, in response to the receiving the wireless service discovery frame.

FIG. 7 illustrates an example embodiment of the invention, wherein examples of removable storage media 700 are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with an example embodiment of the invention.

Although specific example embodiments have been disclosed, a person skilled in the art will understand that changes can be made to the specific example embodiments without departing from the spirit and scope of the invention.

What is claimed is:

1. A method comprising:
composing, by an access point device responsible for coordinating communication in a first wireless network, a service ID indicating support for communication with other access point devices operating in a second neighbor awareness network, wherein the access point device is capable of concurrently operating as an access point in the first wireless network and participating in the second neighbor awareness network; and
transmitting, by the access point device, a wireless service discovery frame to the second neighbor awareness network, the service discovery frame including the composed service ID.

2. The method of claim 1, further comprising:
discovering, by the access point device, at least one of the other access point devices operating in the second neighbor awareness network, through operation of the second neighbor awareness network, in response to the transmitting of the wireless service discovery frame.

3. The method of claim 1, further comprising:
establishing, by the access point device, a communication channel with at least one of the other access point devices operating in the second neighbor awareness network, through operation of the second neighbor awareness network, in response to the transmitting of the wireless service discovery frame.

4. The method of claim 1, wherein the first wireless network is a Wi-Fi network and the service discovery frame includes a publish message that includes the service ID.

5. The method of claim 4, wherein the publish message carried in the service discovery frame includes information about the access point device.

6. The method of claim 1, wherein the first wireless network is a Wi-Fi network and the service discovery frame includes a subscribe message that includes the service ID.

7. The method of claim 6, wherein the subscribe message carried in the service discovery frame includes information about the access point device.

8. A method, comprising:
receiving, by an access point device, a wireless service discovery frame from another access point device operating in a neighbor awareness network, the service discovery frame including a service ID indicating support for communication with access point devices operating in the neighbor awareness network, wherein the access point device is capable of concurrently operating in a wireless network as an access point responsible for coordinating communication in the wireless network and also participating in the neighbor awareness network; and
establishing, by the access point device, a communication channel with the other access point device in the neighbor awareness network, through operation of the neighbor awareness network, in response to the receiving the wireless service discovery frame.

9. The method of claim 8, further comprising:
wherein the wireless network is a Wi-Fi network and the service discovery frame includes either a publish message or a subscribe message that includes the service ID.

10. The method of claim 9, wherein the publish message or the subscribe message carried in the service discovery frame includes information about the access point device.

11. An access point device, comprising:
at least one processor;
at least one memory including computer program code;
the at least one memory and the computer program code configured to, with the at least one processor, cause the access point device at least to:
compose, by the access point device responsible for coordinating communication in a first wireless network, a service ID indicating support for communication with other access point devices operating in a second neighbor awareness network, wherein the access point device is capable of concurrently operating as an access point in the first wireless network and participating in the second neighbor awareness network; and
transmit a wireless service discovery frame to the second neighbor awareness network, the service discovery frame including the composed service ID.

12. The access point device of claim 11, further comprising:
the at least one memory and the computer program code configured to, with the at least one processor, cause the access point device at least to:
discover at least one of the other access point devices operating in the second neighbor awareness network, through operation of the second neighbor awareness network, in response to the transmitting of the wireless service discovery frame.

13. The access point device of claim 11, further comprising:
the at least one memory and the computer program code configured to, with the at least one processor, cause the access point device at least to:
establish a communication channel with at least one of the other access point devices operating in the second neighbor awareness network, through operation of the second neighbor awareness network, in response to the transmitting of the wireless service discovery frame.

14. The access point device of claim 11, wherein the first wireless network is a Wi-Fi network and the service discovery frame includes a publish message that includes the service ID.

15. The access point device of claim 14, wherein the publish message carried in the service discovery frame includes information about the access point device.

16. The access point device of claim 11, wherein the first wireless network is a Wi-Fi network and the service discovery frame includes a subscribe message that includes the service ID.

17. The access point device of claim 16, wherein the subscribe message carried in the service discovery frame includes information about the access point device.

18. An access point device, comprising:
at least one processor;
at least one memory including computer program code;
the at least one memory and the computer program code configured to, with the at least one processor, cause the access point device at least to:
receive a wireless service discovery frame from another access point device operating in a neighbor awareness network, the service discovery frame including a service ID indicating support for communication with access point devices operating in the neighbor awareness network, wherein the access point device is capable of concurrently operating in a wireless network as an access point responsible for coordinating communication in the wireless network and also participating in the neighbor awareness network; and
establish a communication channel with the other access point device in the neighbor awareness network, through operation of the neighbor awareness network, in response to the receiving the wireless service discovery frame.

19. The access point device of claim 18, wherein the wireless network is a Wi-Fi network and the service discovery frame includes either a publish message or a subscribe message that includes the service ID.

20. The access point device of claim 19, wherein the publish message or the subscribe message carried in the service discovery frame includes information about the access point device.

21. A computer program product comprising computer executable program code recorded on a computer readable non-transitory storage medium, the computer executable program code comprising:
code for composing, by an access point device responsible for coordinating communication in a first wireless network, a service ID indicating support for communication with other access point devices operating in a second neighbor awareness network, wherein the access point device is capable of concurrently operating as an access point in the first wireless network and participating in the second neighbor awareness network; and
code for transmitting, by the access point device, a wireless service discovery frame to the second neighbor awareness network, the service discovery frame including the composed service ID.

22. A computer program product comprising computer executable program code recorded on a computer readable non-transitory storage medium, the computer executable program code comprising:
code for receiving, by an access point device, a wireless service discovery frame from another access point device operating in a neighbor awareness network, the service discovery frame including a service ID indicating support for communication with access point devices operating in the neighbor awareness network, wherein the access point device is capable of concurrently operating in a wireless network as an access point responsible for coordinating communication in the wireless network and also participating in the neighbor awareness network; and
code for establishing, by the access point device, a communication channel with the other access point device in the neighbor awareness network, through operation of the neighbor awareness network, in response to the receiving the wireless service discovery frame.
